(19) United States
(12) Patent Application Publication
(10) Pub. No.: US 2018/0255600 A1
(43) Pub. Date: Sep. 6, 2018

(54) DISTRIBUTION TERMINAL, ACQUISITION TERMINAL, DISTRIBUTION SYSTEM, AND DISTRIBUTION METHOD

(71) Applicant: FUJITSU LIMITED, Kawasaki-shi (JP)

(72) Inventors: Koji NAKAMICHI, Yokohama (JP); Naoki HASEGAWA, Kawasaki (JP); Yuka TANAKA, Yokohama (JP); Junji ONO, Fukuoka (JP)

(73) Assignee: FUJITSU LIMITED, Kawasaki-shi (JP)

(21) Appl. No.: 15/909,164

(22) Filed: Mar. 1, 2018

(30) Foreign Application Priority Data
Mar. 2, 2017 (JP) 2017-039431

(51) Int. Cl. H04W 76/18; H04W 76/15

(52) U.S. Cl. CPC H04W 76/18; H04W 8/005; H04W 76/15

(57) ABSTRACT

A distribution terminal includes a memory and a processor coupled to the memory. The processor executes a process including: first transmitting contents-relevant information relevant to contents to an acquisition terminal before wireless communication connection is established, according to a contents-relevant information request which is transmitted from the acquisition terminal; detecting whether or not an error occurs when the contents-relevant information is transmitted; and second transmitting the contents-relevant information to the acquisition terminal after the wireless communication connection is established, in a case in which an occurrence of the error is detected.

### CROSS-REFERENCE TO RELATED APPLICATION

This application is based upon and claims the benefit of priority of the prior Japanese Patent Application No. 2017-039431, filed on Mar. 2, 2017, the entire contents of which are incorporated herein by reference.

### FIELD

The embodiments discussed herein are related to a distribution terminal, an acquisition terminal, a distribution system, and a distribution method.

### BACKGROUND

Recently, for example, a near field communication function has been provided in a communication device, such as a portable terminal such as a smart phone or a tablet, or an electrical household appliance such as a television or a digital camera. Examples of the near field communication function include a Bluetooth (Registered Trademark) communication function or a WiFi (Registered Trademark, wireless fidelity) direct function.

For example, in a distribution system using a WiFi direct function, there is a case where an acquisition terminal such as the portable terminal or the like is sequentially connected to a plurality of peripheral distribution terminals in a near field communication range, and thus, information is acquired. The WiFi direct function has a device discovery function of discovering a device having a WiFi direct function in a near field communication range and a service discovery function of discovering service information provided by the discovered device, in addition to a wireless communication connection function or an information transmission function between terminals.

In the distribution system using the WiFi direct function, the acquisition terminal is capable of discovering a distribution terminal existing in a near field communication range by using a WiFi direct service discovery request message. That is, the acquisition terminal is capable of discovering the distribution terminal existing in the near field communication range as the discovery of the device. For example, the acquisition terminal transmits the WiFi direct service discovery request message in near field communication, and receives the service discovery response message from the distribution terminal, and thus, discovers the distribution terminal existing in the near field communication range. In addition, the acquisition terminal establishes WiFi connection, as wireless communication connection with respect to the discovered distribution terminal, and thus, is capable of acquiring the contents retained in the distribution terminal from the discovered distribution terminal. Accordingly, a user of the acquisition terminal is capable of browsing the contents.

In addition, in the distribution system using the WiFi direct function, the acquisition terminal is capable of acquiring meta-information of the contents from the discovered distribution terminal before the contents are acquired from the discovered distribution terminal, when the distribution terminal in the near field communication range is discovered. That is, the acquisition terminal is capable of discovering the meta-information of the contents (contents-relevant information) retained by the distribution terminal, as the discovery of the service information. For example, the distribution terminal distributes the contents-relevant information relevant to the contents by using the WiFi direct service discovery response message. The contents-relevant information is included in the service discovery response message. The acquisition terminal receives the service discovery response message from the distribution terminal, and thus, is capable of acquiring the contents-relevant information from the service discovery response message.

Thus, in the distribution system using the WiFi direct function, the acquisition terminal is capable of acquiring the contents-relevant information from the discovered distribution terminal before the contents are acquired from the discovered distribution terminal in the near field communication range.

Patent Literature 1: Japanese National Publication of International Patent Application No. 2015-531205

Patent Literature 2: Japanese National Publication of International Patent Application No. 2014-505408

However, there is a limit (an upper limit value) in an information amount transmittable on the service discovery response message. For example, in a case where an information amount of the contents-relevant information included in the service discovery response message is greater than the upper limit value, when the distribution terminal transmits the service discovery response message to the acquisition terminal, the distribution terminal is not capable of transmitting the service discovery response message to the acquisition terminal. In this case, the acquisition terminal is not capable of acquiring the contents-relevant information. In particular, in a case where it is assumed that the distribution terminal distributes a plurality of contents, the information amount increases in proportion to the number of contents. For this reason, it is assumed that in a case where the contents-relevant information of the plurality of contents is transmitted by being included in one service discovery response message, the service discovery response message is not capable of being transmitted (distributed) to the acquisition terminal due to a limit in an information amount of the service discovery response message.

### SUMMARY

According to an aspect of an embodiment, a distribution terminal includes a memory and a processor coupled to the memory. The processor executes a process including: first transmitting contents-relevant information relevant to contents to an acquisition terminal before wireless communication connection is established, according to a contents-relevant information request which is transmitted from the acquisition terminal; detecting whether or not an error occurs when the contents-relevant information is transmitted; and second transmitting the contents-relevant information to the acquisition terminal after the wireless communication connection is established, in a case in which an occurrence of the error is detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a distribution system of this example;

FIG. 2 is a sequence diagram illustrating an example of the distribution service using a WiFi direct function;

FIG. 3 is a diagram illustrating an example of contents-relevant information which is list-displayed on an acquisition terminal;

FIG. 4 is a block diagram illustrating an example of a hardware configuration of a distribution terminal in the distribution system of this example;

FIG. 5 is a block diagram illustrating an example of a functional configuration of a RAM and a CPU in a distribution terminal of a distribution system of a first example;

FIG. 6 is a diagram illustrating an example of a content storage unit in the distribution terminal;

FIG. 7 is a diagram illustrating an example of the content storage unit in the distribution terminal;

FIG. 8 is a diagram illustrating an example of the content storage unit in the distribution terminal;

FIG. 9 is a block diagram illustrating an example of a hardware configuration of the acquisition terminal in the distribution system of this example;

FIG. 10 is a block diagram illustrating an example of a functional configuration of a CPU in an acquisition terminal in the distribution system of the first example;

FIG. 11 is a sequence diagram illustrating an example of an operation of the distribution system of the first example;

FIG. 12 is a block diagram illustrating an example of a functional configuration of a RAM and a CPU in a distribution terminal of a distribution system of a second example;

FIG. 13 is a block diagram illustrating an example of a functional configuration of a CPU in an acquisition terminal of the distribution system of the second example;

FIG. 14 is a sequence diagram illustrating an example of an operation of the distribution system of the second example;

FIG. 15 is a block diagram illustrating an example of a functional configuration of a RAM and a CPU in a distribution terminal of a distribution system of a third example;

FIG. 16 is a block diagram illustrating an example of a functional configuration of a CPU in an acquisition terminal of the distribution system of the third example;

FIG. 17 is a sequence diagram illustrating an example of an operation of the distribution system of the third example;

FIG. 18 is a block diagram illustrating an example of a functional configuration of a RAM and a CPU in a distribution terminal of a distribution system of a fourth example;

FIG. 19 is a diagram illustrating an example of an upper limit value storage unit in the distribution terminal;

FIG. 20 is a block diagram illustrating an example of a functional configuration of a CPU in an acquisition terminal of the distribution system of the fourth example; and

FIG. 21 is a sequence diagram illustrating an example of the operation of the distribution system of the fourth example.

### DESCRIPTION OF EMBODIMENTS

Preferred embodiments of the present invention will be explained with reference to accompanying drawings. Furthermore, the following examples do not limit the disclosed technology. In addition, the following examples may be suitably combined within a range not causing a contradiction.

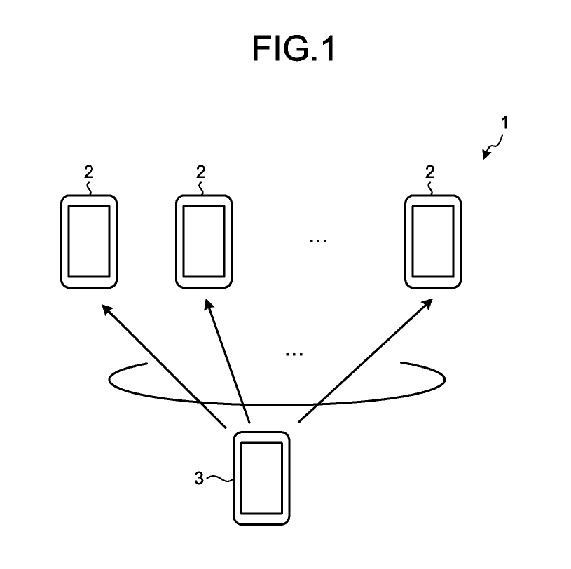

FIG. 1 is a diagram illustrating an example of a distribution system 1 of this example. The distribution system 1 includes a plurality of distribution terminals 2, and an acquisition terminal 3.

Each of the plurality of distribution terminals 2, for example, is provided in facilities such as a retail premises or an event site. The distribution terminal 2, for example, is a communication device (a distribution device) which stores contents, and distributes the stored contents to the peripheral acquisition terminal 3.

The acquisition terminal 3, for example, is a communication device (an acquisition device) which receives the contents distributed from the distribution terminal 2, and displays the received contents. A portable terminal such as a smart phone or a tablet is exemplified as the acquisition terminal 3.

A near field communication function such as a WiFi direct function is provided in the distribution terminal 2 and the acquisition terminal 3. The WiFi direct function includes a device discovery function of discovering a device having a WiFi direct function, which exists in a near field communication range, in addition to a wireless communication connection function or an information transmission function between the distribution terminal 2 and the acquisition terminal 3, between the distribution terminals 2, and between the acquisition terminals 3. Further, the WiFi direct function includes a service discovery function of discovering service information provided by a discovered device.

In the distribution system 1 using the WiFi direct function, it is possible for the acquisition terminal 3 to discover the distribution terminal 2 existing in the near field communication range by using a WiFi direct service discovery request message. That is, the acquisition terminal 3 is capable of discovering the distribution terminal 2 existing in the near field communication range, as the discovery of the device. For example, the acquisition terminal 3 transmits a service discovery request message of WiFi direct in near field communication, and receives the service discovery response message from the distribution terminal 2, and thus, discovers the distribution terminal 2 existing in the near field communication range. In addition, the acquisition terminal 3 establishes WiFi connection, as wireless communication connection with respect to the discovered distribution terminal 2, and thus, the contents retained by the distribution terminal 2 can be acquired from the discovered distribution terminal 2. The contents, for example, are information contents such as usage guide of facilities such as retail premises or event sites, and advertisement or sales information of the facilities. Accordingly, a user of the acquisition terminal 3 is capable of browsing the contents.

In addition, in the distribution system 1 using the WiFi direct function, the acquisition terminal 3 is capable of acquiring meta-information of the contents from the discovered distribution terminal 2 before the contents are acquired from the discovered distribution terminal 2, when the distribution terminal 2 in the near field communication range is discovered. That is, the acquisition terminal 3 is capable of discovering the meta-information of the contents (the contents-relevant information) retained by the distribution terminal 2, as the discovery of the service information. For example, the distribution terminal 2 distributes the contents-relevant information relevant to the contents by using the service discovery response message of the WiFi direct. The contents-relevant information is included in the service discovery response message. Examples of the contents-relevant information include a content name, a service name, or the like. The acquisition terminal 3 receives the service discovery response message from the distribution terminal 2, and thus, is capable of acquiring the contents-relevant information from the service discovery response message.

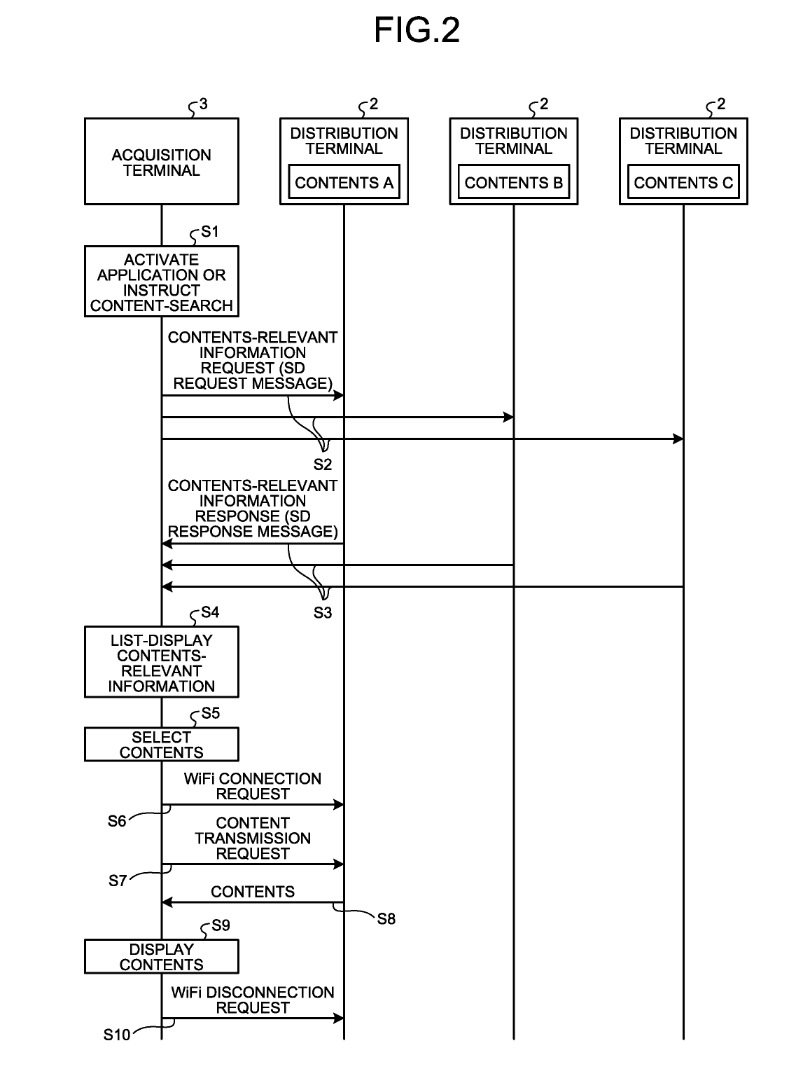

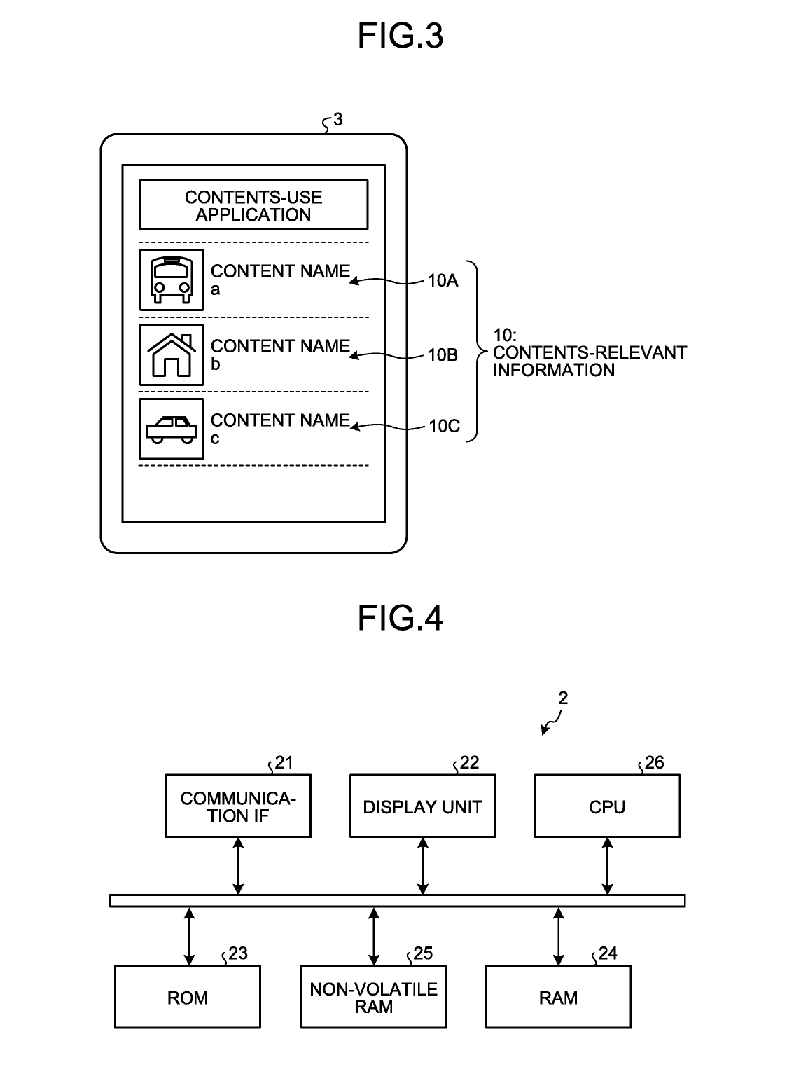

FIG. 2 is a sequence diagram illustrating an example of distribution service using the WiFi direct function. FIG. 3 is a diagram illustrating an example of contents-relevant information 10 to be list-displayed on the acquisition terminal 3.

First, as illustrated in FIG. 2, in the acquisition terminal 3, a contents-use application (hereinafter, described as an application) is activated according to an operation of the user. Alternatively, in the acquisition terminal 3, a content-search instruction is performed on the application according to the operation of the user (Step S1). At this time, the acquisition terminal 3 transmits a service discovery (SD) request message in near field communication, as a contents-relevant information request for requesting the contents-relevant information (Step S2). The SD request message transmitted from the acquisition terminal 3 is transmitted by a broadcast.

For example, the distribution terminal 2 retaining contents A, the distribution terminal 2 retaining contents B, and the distribution terminal 2 retaining contents C exist in the near field communication range. In this case, three distribution terminals 2 respectively retaining the contents A, B, and C transmit an SD response message in near field communication according to the SD request message transmitted from the acquisition terminal 3, as a contents-relevant information response (Step S3). The contents-relevant information relevant to the contents A, B, and C is included in each of the SD response messages transmitted from three distribution terminals 2.

The acquisition terminal 3 receives the SD response messages transmitted from three distribution terminals 2, and thus, discovers the distribution terminal 2 existing in the near field communication range. At this time, the acquisition terminal 3 acquires the contents-relevant information included in each of three received SD response messages, and list-displays the acquired contents-relevant information (Step S4).

As illustrated in FIG. 3, for example, contents-relevant information 10A to 10C are list-displayed on the acquisition terminal 3, as the contents-relevant information 10. The contents-relevant information 10A is the contents-relevant information of the contents A, and includes an icon of the contents A, and a content name a, which is a name of the contents A. The contents-relevant information 10B is the contents-relevant information of the contents B, and includes an icon of the contents B, and a content name b, which is a name of the contents B. The contents-relevant information 10C is the contents-relevant information of the contents C, and includes an icon of the contents C, and a content name c, which is a name of the contents C.

The user selects one content name in the content names list-displayed on the acquisition terminal 3. For example, as illustrated in FIG. 2, the user selects the content name of the contents A (Step S5). At this time, the acquisition terminal 3 transmits a WiFi connection request to the distribution terminal 2 retaining the contents A, as a wireless communication connection request for requesting connection of wireless communication (Step S6). The distribution terminal 2 retaining the contents A establishes the WiFi connection according to the WiFi connection request transmitted from the acquisition terminal 3, as the wireless communication connection between the acquisition terminal 3 and the distribution terminal 2 retaining the contents A.

In a case where the WiFi connection is performed between the acquisition terminal 3 and the distribution terminal 2 retaining the contents A, the acquisition terminal 3 transmits a content transmission request for requesting transmission of the contents A to the distribution terminal 2 retaining the contents A (Step S7). The distribution terminal 2 retaining the contents A transmits the contents A according to the content transmission request transmitted from the acquisition terminal 3 (Step S8). The acquisition terminal 3 acquires the contents A from the distribution terminal 2 retaining the contents A, and displays the contents A (Step S9).

For example, the acquisition terminal 3 transmits a WiFi disconnection request to the distribution terminal 2 retaining the contents A, as a wireless communication disconnection request for requesting disconnection of the wireless communication in the connection (Step S10). The distribution terminal 2 retaining the contents A performs the disconnection of the WiFi connection between the acquisition terminal 3 and the distribution terminal 2 retaining the contents A, according to the WiFi disconnection request transmitted from the acquisition terminal 3.

Thus, in the distribution system 1 using the WiFi direct function, the acquisition terminal 3 is capable of acquiring the contents-relevant information from the discovered distribution terminal 2 before the contents are acquired from the distribution terminal 2 discovered in the near field communication range.

However, there is a limit (an upper limit value) in an information amount transmittable on the SD response message. For example, an information amount of the contents-relevant information is represented by byte as information unit, and an upper limit value thereof is different according to the model of the terminal, and is caused by a memory or a processing amount of the terminal constraint. It is possible for the distribution terminal 2 to transmit the SD response message to the acquisition terminal 3 in a case where the information amount of the contents-relevant information included in the SD response message is greater than the upper limit value, when the distribution terminal 2 transmits the SD response message to the acquisition terminal 3. In this case, the acquisition terminal 3 is not capable of acquiring the contents-relevant information.

In particular, in a case where it is assumed that the distribution terminal 2 distributes a plurality of contents, the information amount increases in proportion to the number of contents. For this reason, it is assumed that in a case where the contents-relevant information of the plurality of contents is transmitted by being included in one SD response message, the SD response message is not capable of being transmitted to the acquisition terminal 3 due to a limit of the information amount of the SD response message. As a result thereof, the acquisition terminal 3 is not capable of acquiring the contents-relevant information.

In this example, even in a case where an error occurs when the SD response message including the contents-relevant information, of which the information amount is greater than the upper limit value, is transmitted, the distribution terminal 2 is capable of reliably distributing the contents-relevant information to the acquisition terminal 3. An example of this case will be described as a first example.

### [a] First Example

FIG. 4 is a block diagram illustrating an example of a hardware configuration of the distribution terminal 2 in the distribution system 1 of this example. The distribution terminal 2 includes a communication interface (hereinafter, referred to as a communication IF) 21, a display unit 22, a read only memory (ROM) 23, a random access memory (RAM) 24, a non-volatile RAM 25, and a central processing unit (CPU) 26.

The communication IF 21, for example, is an interface which performs communication such as general wireless communication or near field communication.

The display unit 22, for example, is an output interface which displays various information items such as contents, icons, or lists. For example, in a case where the display unit 22 is a touch panel display, the display unit 22 has a function of an input interface which receives an operation input from the user, and a function of an output interface which displays various information items described above.

The ROM 23 is an area which stores various information items such as a program. The RAM 24, for example, is a working area or the like, which is used by the CPU 26. The non-volatile RAM 25, for example, is an area which stores various information items such as each downloaded program.

The CPU 26 controls the entire distribution terminal 2. The CPU 26 decompresses the program stored in the ROM 23 on the RAM 24, and executes a processing function by using the program decompressed on the RAM 24 as a process.

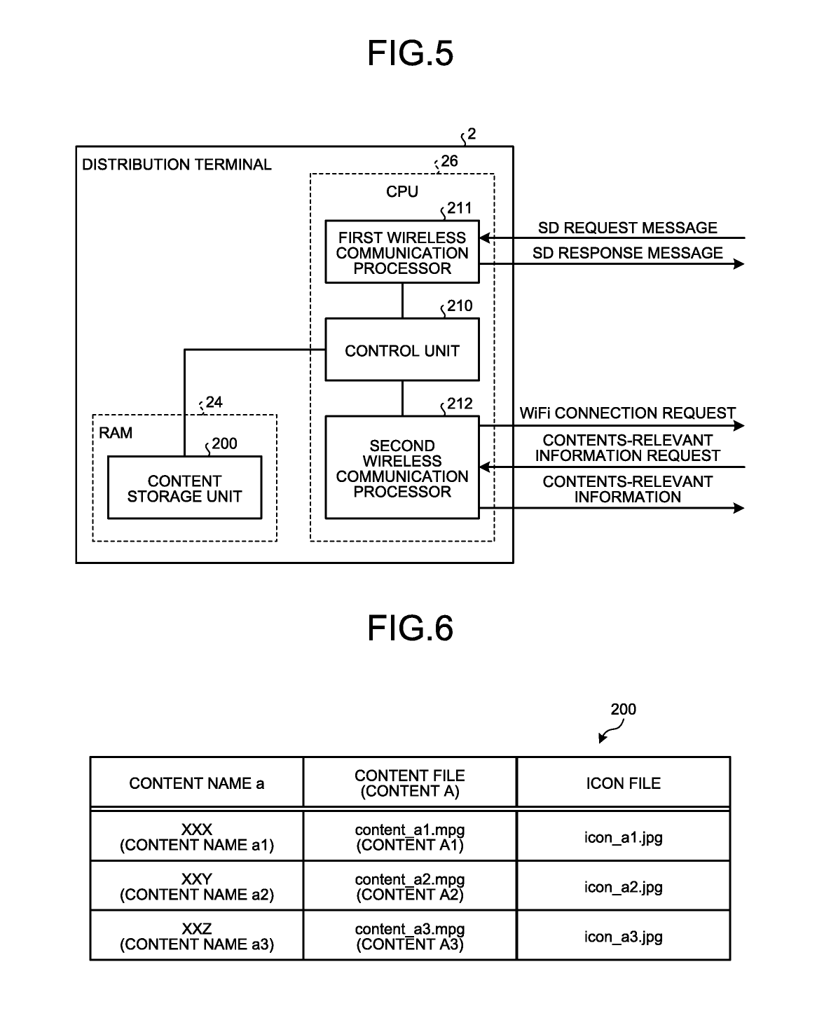

FIG. 5 is a block diagram illustrating an example of a functional configuration of the RAM 24 and the CPU 26 in the distribution terminal 2 of the distribution system 1 of the first example. As illustrated in FIG. 5, the RAM 24 in the distribution terminal 2 is provided with a content storage unit 200. FIGS. 6 to 8 are diagrams illustrating an example of the content storage unit 200 in the distribution terminal 2.

As illustrated in FIG. 6, the content storage unit 200 in the distribution terminal 2 retaining the contents A stores the contents A, the icon of the contents A, and the content name a in association with each other. For example, the contents A are configured of three contents A1 to A3. For example, the content storage unit 200 stores a file of “content_a1.mpg” of the contents A1, a file of “icon_a1.jpg” of an icon of the contents A1, and a content name a1 of “XXX” in association with each other. In addition, the content storage unit 200 stores a file of “content_a2.mpg” of the contents A2, a file of “icon_a2.jpg” of an icon of the contents A2, and a content name a2 of “XXY” in association with each other. In addition, the content storage unit 200 stores a file of “content_a3.mpg” of the contents A3, a file of “icon_a3.jpg” of an icon of the contents A3, and a content name a3 of “XXZ” in association with each other. In this case, the contents-relevant information 10A illustrated in FIG. 3 includes the icons of the contents A1 to A3, and the content names a1 to a3.

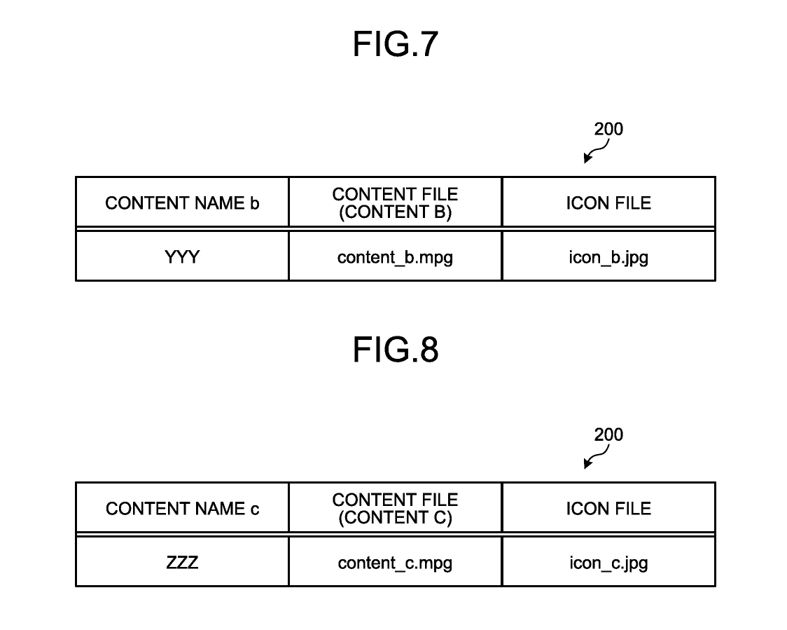

As illustrated in FIG. 7, the content storage unit 200 in the distribution terminal 2 retaining the contents B stores the contents B, the icon of the contents B, and the content name b in association with each other. For example, the content storage unit 200 stores a file of “content_b.mpg” of the contents B, a file of “icon_b.jpg” of the icon of the contents B, and the content name b of “YYY” in association with each other. In this case, the contents-relevant information 10B illustrated in FIG. 3 includes the icon of the contents B, and the content name b.

As illustrated in FIG. 8, the content storage unit 200 in the distribution terminal 2 retaining the contents C stores the contents C, the icon of the contents C, and the content name c in association with each other. For example, the content storage unit 200 stores a file of “content_c.mpg” of the contents C, a file of “icon_c.jpg” of the icon of the contents C, and the content name c of “ZZZ” in association with each other. In this case, the contents-relevant information 10C illustrated in FIG. 3 includes the icon of the contents C, and the content name c.

As illustrated in FIG. 5, the CPU 26 in the distribution terminal 2 is provided with a control unit 210, a first wireless communication processor 211, and a second wireless communication processor 212.

In a case where the own terminal exists in the near field communication range, the first wireless communication processor 211, for example, receives the SD request message transmitted from the acquisition terminal 3. When the SD request message is received, the first wireless communication processor 211 reads out the contents-relevant information from the content storage unit 200. The first wireless communication processor 211 transmits the SD response message including the contents-relevant information in the near field communication, as the contents-relevant information response.

In a case where the control unit 210 detects a transmission error, the second wireless communication processor 212 transmits the WiFi connection request to the acquisition terminal 3 by using an IP address included in the SD request message, as the wireless communication connection request. The second wireless communication processor 212 receives the contents-relevant information request transmitted from the acquisition terminal 3. In this case, the second wireless communication processor 212 transmits the contents-relevant information according to the contents-relevant information request.

The control unit 210 controls the entire CPU 26. When the first wireless communication processor 211 transmits the SD response message to the acquisition terminal 3, there is a case where the information amount of the contents-relevant information included in the SD response message is greater than the upper limit value. In this case, the control unit 210 detects that the SD response message including the contents-relevant information, of which the information amount is greater than the upper limit value, is not capable of being transmitted, as the transmission error (for example, the occurrence of an exception, or the like).

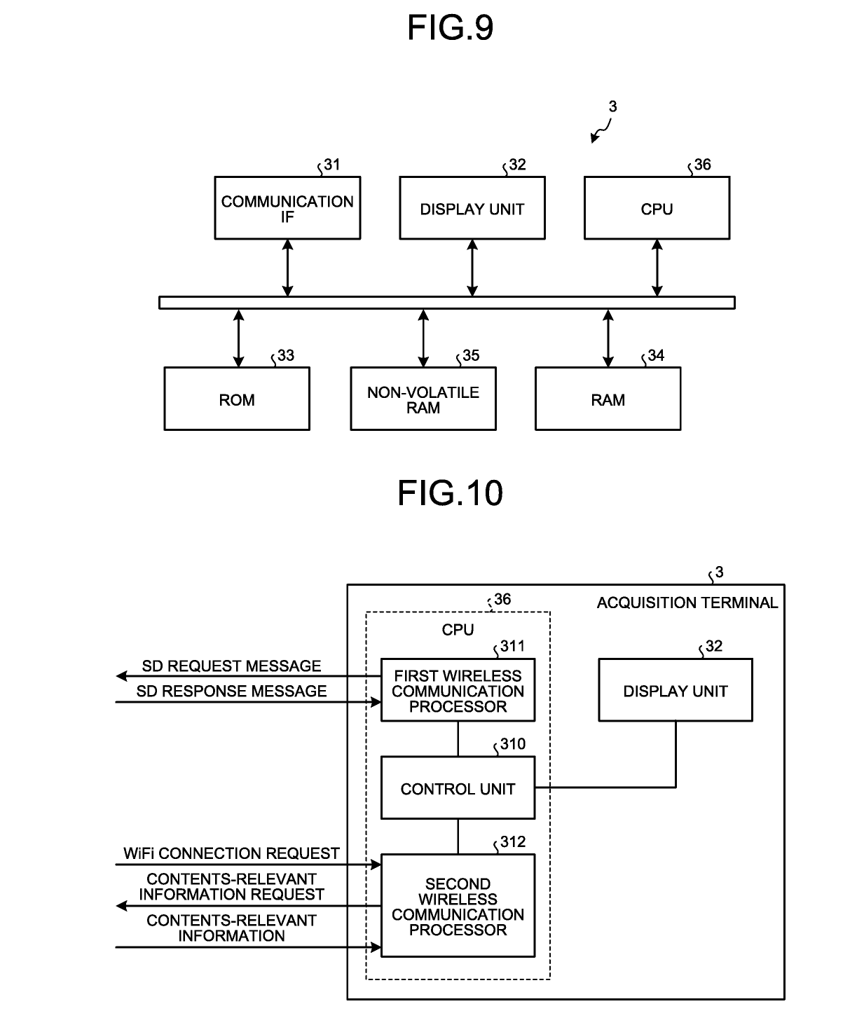

FIG. 9 is a block diagram illustrating an example of a hardware configuration of the acquisition terminal 3 in the distribution system 1 of this example. The acquisition terminal 3 includes a communication interface (hereinafter, referred to as a communication IF) 31, a display unit 32, a read only memory (ROM) 33, a random access memory (RAM) 34, a non-volatile RAM 35, and a central processing unit (CPU) 36.

The communication IF 31, for example, is an interface which performs communication such as general wireless communication or near field communication.

The display unit 32, for example, is an output interface which displays various information items such as contents, icons, or lists. For example, in a case where the display unit 32 is a touch panel display, the display unit 32 has a function of an input interface which receives an operation input from the user, and a function of an output interface which displays various information items described above.

The ROM 33 is an area which stores various information items such as a program. The RAM 34, for example, is a working area or the like, which is used by the CPU 36. The non-volatile RAM 35, for example, is an area which stores various information items such as each downloaded program.

The CPU 36 controls the entire acquisition terminal 3. The CPU 36 decompresses the program stored in the ROM 33 on the RAM 34, and executes a processing function by using the program decompressed on the RAM 34 as a process.

FIG. 10 is a block diagram illustrating an example of a functional configuration of the CPU 36 in the acquisition terminal 3 of the distribution system 1 of the first example. The CPU 36 in the acquisition terminal 3 is provided with a control unit 310, a first wireless communication processor 311, and a second wireless communication processor 312.

When the application is activated, or when the content-search instruction is performed on the application, the first wireless communication processor 311 transmits the SD request message including the IP address of the own terminal in the near field communication, as the contents-relevant information request. The SD request message is transmitted from the acquisition terminal 3 by a broadcast. The first wireless communication processor 311 receives the SD response message transmitted from the distribution terminal 2, and thus, discovers the distribution terminal 2 existing in the near field communication range. When the SD response message is received, the first wireless communication processor 311 acquires the contents-relevant information included in the received SD response message.

In a case where the WiFi connection request transmitted from the distribution terminal 2 is received, the second wireless communication processor 312 establishes the WiFi connection according to the WiFi connection request, as the wireless communication connection between the acquisition terminal 3 and the distribution terminal 2. In a case where the WiFi connection is performed between the acquisition terminal 3 and the distribution terminal 2, the second wireless communication processor 312 transmits the contents-relevant information request to the distribution terminal 2, and acquires the contents-relevant information from the distribution terminal 2.

The control unit 310 controls the entire CPU 36. In a case where the second wireless communication processor 312 receives the WiFi connection request with respect to the transmission of the SD request message from the first wireless communication processor 311, the control unit 310 detects that an error occurs on the distribution terminal 2 side. In addition, the control unit 310 list-displays the acquired contents-relevant information on the display unit 32.

In the first example, in the acquisition terminal 3, the first wireless communication processor 311 executes Steps S1 and S2 of FIG. 2, the second wireless communication processor 312 executes Steps S6, S7, and S10 of FIG. 2, and the control unit 310 executes Steps S4, S5, and S9 of FIG. 2. In each of the distribution terminals 2, the first wireless communication processor 211 executes Step S3 of FIG. 2, and the second wireless communication processor 212 executes Step S8 of FIG. 2.

Further, in the first example, as described below, even in a case where an error occurs when the SD response message including the contents-relevant information, of which the information amount is greater than the upper limit value, is transmitted, the distribution terminal 2 is capable of reliably distributing the contents-relevant information to the acquisition terminal 3.

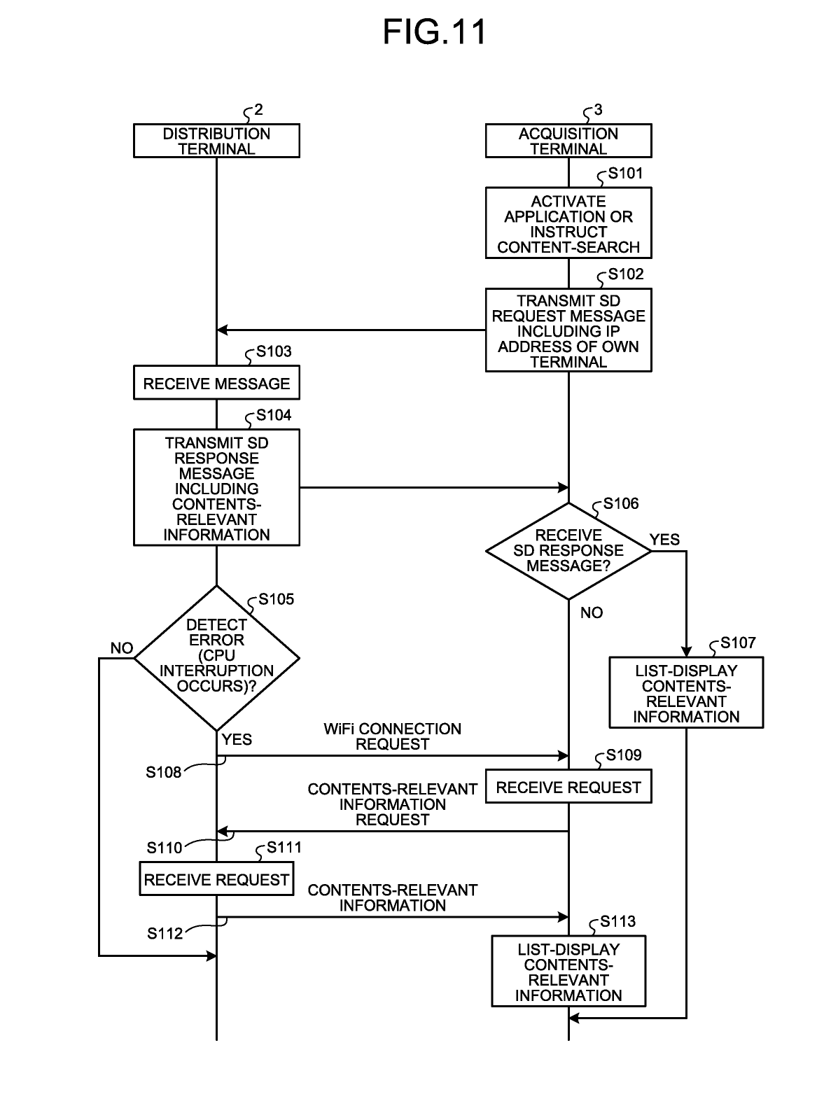

FIG. 11 is a sequence diagram illustrating an example of an operation of the distribution system 1 of first example.

In the acquisition terminal 3, the application is activated according to the operation of the user. Alternatively, in the acquisition terminal 3, the content-search instruction is performed on the application according to the operation of the user (Step S101). At this time, the first wireless communication processor 311 of the acquisition terminal 3 transmits the SD request message including the IP address of the own terminal in the near field communication, as the contents-relevant information request (Step S102). The SD request message is transmitted from the acquisition terminal 3 by a broadcast.

For example, the distribution terminal 2 retaining the contents A exists in the near field communication range. In this case, in the distribution terminal 2 retaining the contents A, the first wireless communication processor 211 receives the SD request message transmitted from the acquisition terminal 3 (Step S103). When the SD request message is received, the first wireless communication processor 211 reads out the contents-relevant information 10A from the content storage unit 200. The contents-relevant information 10A is information relevant to the contents A (the contents A1 to A3), and includes the icons of the contents A1 to A3 and the content names a1 to a3. The first wireless communication processor 211 transmits the SD response message including the contents-relevant information 10A in the near field communication, as the contents-relevant information response (Step S104).

For example, in the distribution terminal 2 retaining the contents A, when the first wireless communication processor 211 transmits the SD response message to the acquisition terminal 3, the information amount of the contents-relevant information 10A included in the SD response message is not greater than the upper limit value. In this case, in the distribution terminal 2 retaining the contents A, the SD response message can be transmitted, and thus, the CPU 26 does not detect the transmission error described below. That is, interrupt processing of the CPU 26 does not occur (Step S105: No). The first wireless communication processor 311 of the acquisition terminal 3 receives the SD response message transmitted from the distribution terminal 2 retaining the contents A, and thus, discovers the distribution terminal 2 existing in the near field communication range (Step S106: Yes). At this time, the first wireless communication processor 311 of the acquisition terminal 3 acquires the contents-relevant information 10A included in the received SD response message. The control unit 310 of the acquisition terminal 3 list-displays the icons of the contents A1 to A3 and the content names a1 to a3 on the display unit 32, as the acquired contents-relevant information 10A (Step S107).

On the other hand, in the distribution terminal 2 retaining the contents A, when the first wireless communication processor 211 transmits the SD response message to the acquisition terminal 3, the information amount of the contents-relevant information 10A included in the SD response message is greater than the upper limit value. In this case, in the distribution terminal 2 retaining the contents A, the control unit 210 detects that the SD response message including the contents-relevant information 10A, of which the information amount is greater than the upper limit value, is not capable of being transmitted from the own terminal, as the transmission error. That is, the interrupt processing of the CPU 26 occurs (Step S105: Yes). As a result thereof, the first wireless communication processor 311 of the acquisition terminal 3 is not capable of receiving the SD response message from the distribution terminal 2 retaining the contents A (Step S106: No).

Therefore, in a case where the control unit 210 detects the transmission error, the distribution terminal 2 retaining the contents A performs the following processing.

First, in the distribution terminal 2 retaining the contents A, the second wireless communication processor 212 transmits the WiFi connection request to the acquisition terminal 3 by using the IP address included in the SD request message, as the wireless communication connection request (Step S108).

Next, the second wireless communication processor 312 of the acquisition terminal 3 receives the WiFi connection request transmitted from the distribution terminal 2 retaining the contents A (Step S109). The second wireless communication processor 312 receives the WiFi connection request with respect to the transmission of the SD request message from the first wireless communication processor 311, and thus, the control unit 310 of the acquisition terminal 3 detects that an error occurs on the distribution terminal 2 side. In this case, the second wireless communication processor 312 of the acquisition terminal 3 establishes the WiFi connection according to the WiFi connection request, as the wireless communication connection between the acquisition terminal 3 and the distribution terminal 2 retaining the contents A. In a case where the WiFi connection is performed between the acquisition terminal 3 and the distribution terminal 2 retaining the contents A, the second wireless communication processor 312 of the acquisition terminal 3 transmits the contents-relevant information request to the distribution terminal 2 retaining the contents A (Step S110).

Next, in the distribution terminal 2 retaining the contents A, the second wireless communication processor 212 receives the contents-relevant information request transmitted from the acquisition terminal 3 (Step S111). In this case, the second wireless communication processor 212 transmits the contents-relevant information 10A according to the contents-relevant information request (Step S112). The second wireless communication processor 312 of the acquisition terminal 3 acquires the contents-relevant information 10A from the distribution terminal 2 retaining the contents A. The control unit 310 of the acquisition terminal 3 list-displays the icons of the contents A1 to A3 and the content names a1 to a3 on the display unit 32, as the acquired contents-relevant information 10A (Step S113).

After that, Steps S5, and S7 to S10 of FIG. 2 are performed. For example, in Step S5, the user selects the content name a1 of the contents A1. In Step S7, the second wireless communication processor 312 of the acquisition terminal 3 transmits the content transmission request for requesting the transmission of the contents A1 to the distribution terminal 2 retaining the contents A. In Step S8, the second wireless communication processor 212 of the distribution terminal 2 retaining the contents A transmits the contents A1 according to the content transmission request transmitted from the acquisition terminal 3. In Step S9, the second wireless communication processor 312 of the acquisition terminal 3 acquires the contents A1 from the distribution terminal 2 retaining the contents A1. The control unit 310 of the acquisition terminal 3 displays the acquired contents A1 on the display unit 32. Accordingly, the user of the acquisition terminal 3 is capable of browsing the contents A1.

As described above, in the distribution system 1 of the first example, the acquisition terminal 3 transmits the contents-relevant information request (the SD request message) to the distribution terminal 2 before the wireless communication connection (the WiFi connection) is established. The first wireless communication processor 211 of the distribution terminal 2 transmits the contents-relevant information 10A relevant to the contents A (the SD response message) to the acquisition terminal 3, according to the contents-relevant information request (the SD request message). The control unit 210 of the distribution terminal 2 detects whether or not an error occurs when the first wireless communication processor 211 transmits the contents-relevant information 10A (the SD response message). In a case where the control unit 210 detects the occurrence of an error, the second wireless communication processor 212 of the distribution terminal 2 transmits the contents-relevant information 10A to the acquisition terminal 3 after the wireless communication connection (the WiFi connection) is established. For this reason, in the distribution system 1 of the first example, the distribution terminal 2 is capable of reliably distributing the contents-relevant information to the acquisition terminal 3. In addition, in a case where the contents-relevant information 10A is not capable of being acquired from the distribution terminal 2 when the contents-relevant information request (the SD request message) is transmitted, the acquisition terminal 3 is capable of acquiring the contents-relevant information after the wireless communication connection (the WiFi connection) is established.

In the distribution terminal 2 of the distribution system 1 of the first example, for example, the control unit 210 detects the occurrence of an error when the first wireless communication processor 211 transmits the contents-relevant information 10A (the SD response message). In this case, the second wireless communication processor 212 transmits the wireless communication connection request (the WiFi connection request), which establishes the wireless communication connection (the WiFi connection), to the acquisition terminal 3. The second wireless communication processor 212 transmits the contents-relevant information 10A to the acquisition terminal 3 after the wireless communication connection (the WiFi connection) is established.

Accordingly, in the distribution system 1 of a second example, even in a case where an error occurs when the SD response message including the contents-relevant information, of which the information amount is greater than the upper limit value, is transmitted, the distribution terminal 2, for example, is capable of reliably distributing the contents-relevant information to the acquisition terminal 3.

In the first example, in a case where an error occurs when the SD response message including the contents-relevant information, of which the information amount is greater than the upper limit value, is transmitted, the distribution terminal 2 requests the WiFi connection with respect to the acquisition terminal 3. As a result thereof, the acquisition terminal 3 acquires the contents-relevant information according to the WiFi connection between the distribution terminal 2 and the acquisition terminal 3. However, the embodiments are not limited thereto. For example, in a case where an error occurs when the distribution terminal 2 transmits the SD response message to the acquisition terminal 3, and thus, the acquisition terminal 3 is not capable of acquiring the contents-relevant information from the SD response message, the acquisition terminal 3 may request the WiFi connection with respect to the distribution terminal 2. An example of this case will be described below as the second example. Furthermore, in the second example, the same reference numerals will be applied to the same constituents as those of the first example, and the repeated description of the constituents and the operations will be omitted.

### [b] Second Example

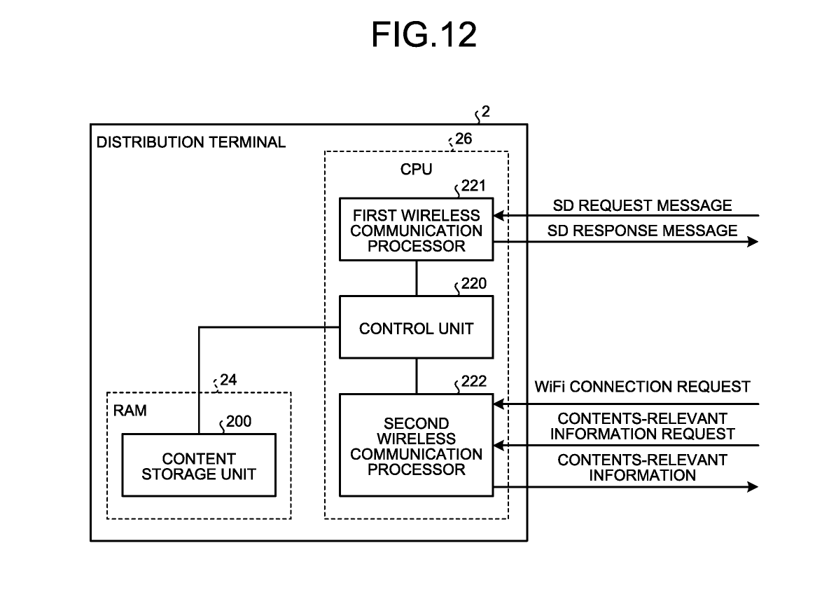

FIG. 12 is a block diagram illustrating an example of a functional configuration of the RAM 24 and the CPU 26 in the distribution terminal 2 of the distribution system 1 of the second example. The CPU 26 in the distribution terminal 2 is provided with a control unit 220, a first wireless communication processor 221, and a second wireless communication processor 222.

In a case where the own terminal exists in the near field communication range, the first wireless communication processor 221, for example, receives the SD request message transmitted from the acquisition terminal 3. When the SD request message is received, the first wireless communication processor 221 reads out contents-relevant information from the content storage unit 200. The first wireless communication processor 221 transmits the SD response message including the contents-relevant information in the near field communication, as the contents-relevant information response.

In a case where the control unit 220 detects the transmission error, the first wireless communication processor 221 transmits the SD response message including the IP address of the own terminal to the acquisition terminal 3, without including the contents-relevant information 10A in the SD response message. Alternatively, the first wireless communication processor 221 transmits a second SD response message including an error occurrence flag and the IP address of the own terminal to the acquisition terminal 3, without including the contents-relevant information 10A in the SD response message. The error occurrence flag included in the second SD response message (the SD response message of the second time) is information indicating the effect that an error occurs when a first SD response message (the SD response message of the first time) is transmitted.

In a case where the WiFi connection request transmitted from the acquisition terminal 3 is received, the second wireless communication processor 222 establishes the WiFi connection according to the WiFi connection request, as the wireless communication connection between the acquisition terminal 3 and the distribution terminal 2. In a case where the contents-relevant information request transmitted from the acquisition terminal 3 is received, when the WiFi connection is performed between the acquisition terminal 3 and the distribution terminal 2, the second wireless communication processor 222 transmits the contents-relevant information according to the contents-relevant information request.

The control unit 220 controls the entire CPU 26. When the first wireless communication processor 221 transmits the SD response message to the acquisition terminal 3, there is a case where the information amount of the contents-relevant information included in the SD response message is greater than the upper limit value. In this case, the control unit 220 detects that the SD response message including the contents-relevant information, of which the information amount is greater than the upper limit value, is not capable of being transmitted, as the transmission error (for example, the occurrence of the exception, or the like).

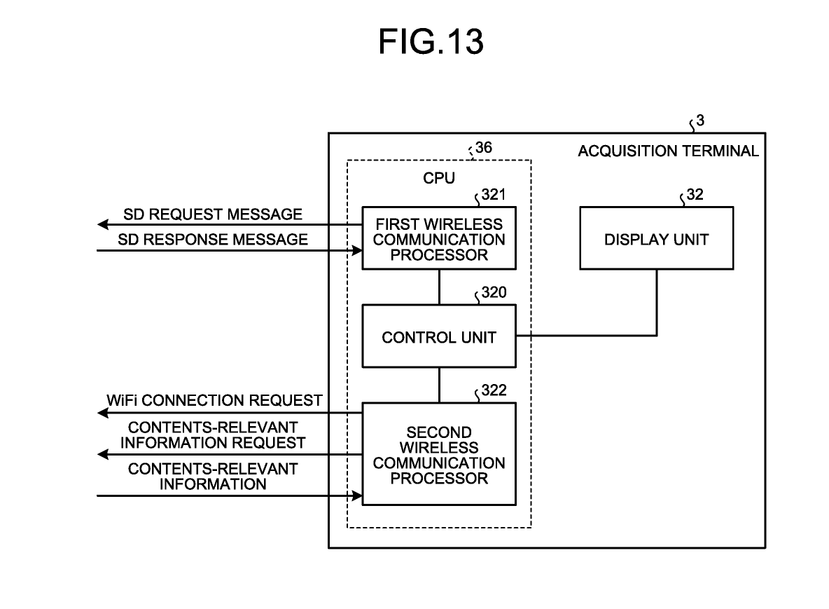

FIG. 13 is a block diagram illustrating an example of a functional configuration of the CPU 36 in the acquisition terminal 3 of the distribution system 1 of the second example. The CPU 36 in the acquisition terminal 3 is provided with a control unit 320, a first wireless communication processor 321, and a second wireless communication processor 322.

When the application is activated, or when the content-search instruction is performed on the application, the first wireless communication processor 321 transmits the SD request message in the near field communication, as the contents-relevant information request. The SD request message is transmitted from the acquisition terminal 3 by a broadcast. The first wireless communication processor 321 receives the SD response message transmitted from the distribution terminal 2, and thus, discovers the distribution terminal 2 existing in the near field communication range. When the SD response message is received, the first wireless communication processor 321 acquires the contents-relevant information included in the received SD response message.

On the other hand, in a case where the contents-relevant information 10A is not included in the received SD response message, the first wireless communication processor 321 recognizes that the contents-relevant information is not capable of being acquired from the SD response message in the near field communication. Alternatively, in a case where the error occurrence flag is included in the received SD response message, the first wireless communication processor 321 of the acquisition terminal 3 recognizes that the contents-relevant information is not capable of being acquired from the SD response message in the near field communication. In this case, the second wireless communication processor 322 transmits the WiFi connection request to the distribution terminal 2 by using the IP address included in the received SD response message, as the wireless communication connection request.

In a case where the WiFi connection is performed between the acquisition terminal 3 and the distribution terminal 2, the second wireless communication processor 322 transmits the contents-relevant information request to the distribution terminal 2, and acquires the contents-relevant information from the distribution terminal 2.

The control unit 320 controls the entire CPU 36. In a case where the SD response message including the error occurrence flag (an error notification) is received by the first wireless communication processor 321, the control unit 320 detects that an error occurs on the distribution terminal 2 side. In addition, the control unit 320 list-displays the acquired contents-relevant information on the display unit 32.

In the second example, in the acquisition terminal 3, the first wireless communication processor 321 executes Steps S1 and S2 of FIG. 2, the second wireless communication processor 322 executes Steps S6, S7, and S10 of FIG. 2, and the control unit 320 executes Steps S4, S5, and S9 of FIG. 2. In each of the distribution terminals 2, the first wireless communication processor 221 executes Step S3 of FIG. 2, and the second wireless communication processor 222 executes Step S8 of FIG. 2.

Further, in the second example, as described below, in a case where an error occurs when the SD response message including the contents-relevant information, of which the information amount is greater than the upper limit value, is transmitted, the distribution terminal 2 is capable of reliably distributing the contents-relevant information to the acquisition terminal 3.

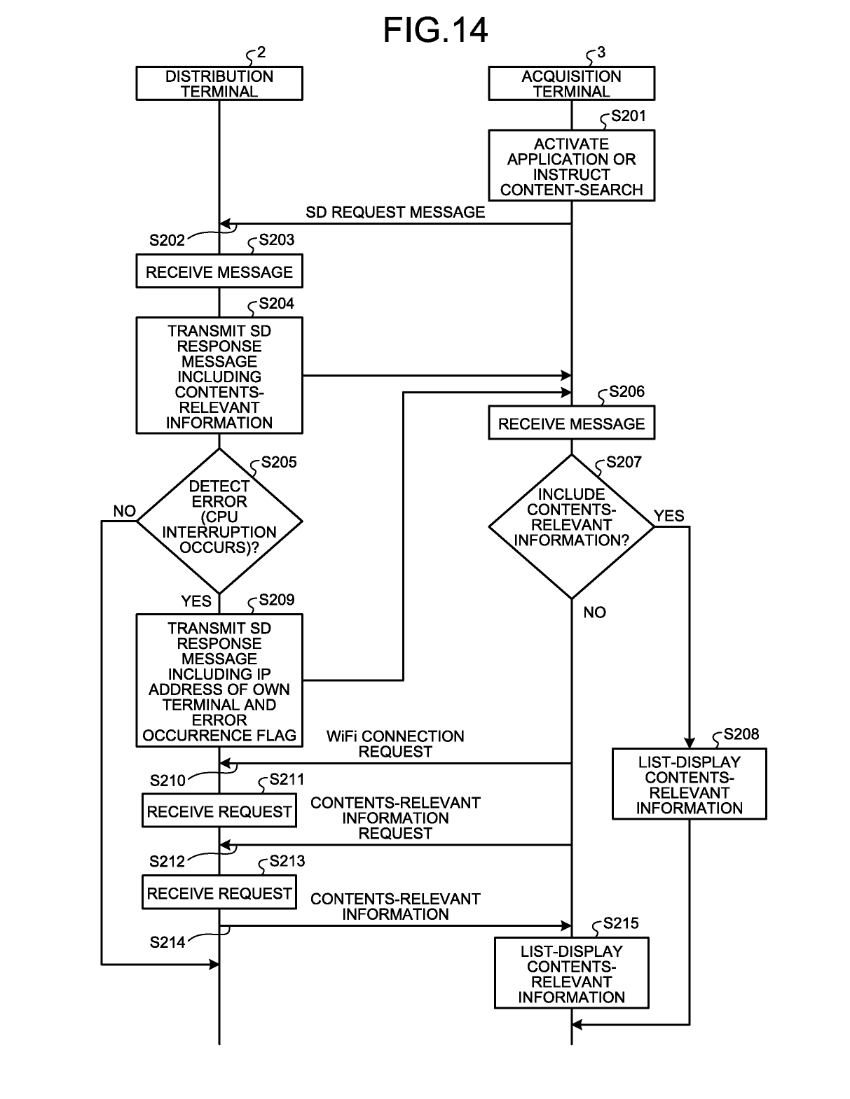

FIG. 14 is a sequence diagram illustrating an example of the operation of the distribution system 1 of the second example.

In the acquisition terminal 3, the application is activated according to the operation of the user. Alternatively, in the acquisition terminal 3, the content-search instruction is performed on the application according to the operation of the user (Step S201). At this time, the first wireless communication processor 321 of the acquisition terminal 3 transmits the SD request message in the near field communication, as the contents-relevant information request (Step S202). The SD request message is transmitted from the acquisition terminal 3 by a broadcast.

For example, the distribution terminal 2 retaining the contents A exists in the near field communication range. In this case, in the distribution terminal 2 retaining the contents A, the first wireless communication processor 221 receives the SD request message transmitted from the acquisition terminal 3 (Step S203). When the SD request message is received, the first wireless communication processor 221 reads out the contents-relevant information 10A from the content storage unit 200. The contents-relevant information 10A is information relevant to the contents A (the contents A1 to A3), and includes the icons of the contents A1 to A3, and the content names a1 to a3. The first wireless communication processor 221 transmits the SD response message including the contents-relevant information 10A in the near field communication, as the contents-relevant information response (Step S204).

For example, in the distribution terminal 2 retaining the contents A, when the first wireless communication processor 221 transmits the SD response message to the acquisition terminal 3, there is a case where the information amount of the contents-relevant information 10A included in the SD response message is not greater than the upper limit value. In this case, in the distribution terminal 2 retaining the contents A, the SD response message is capable of being transmitted, and thus, the CPU 26 does not detect the transmission error described below. That is, the interrupt processing of the CPU 26 does not occur (Step S205: No). The first wireless communication processor 321 of the acquisition terminal 3 receives the SD response message transmitted from the distribution terminal 2 retaining the contents A, and thus, discovers the distribution terminal 2 existing in the near field communication range (Step S206). At this time, the first wireless communication processor 321 of the acquisition terminal 3 acquires the contents-relevant information 10A included in the received SD response message (Step S207: Yes). The control unit 320 of the acquisition terminal 3 list-displays the icons of the contents A1 to A3, and the content names a1 to a3 on the display unit 32, as the acquired contents-relevant information 10A (Step S208).

On the other hand, in the distribution terminal 2 retaining the contents A, when the first wireless communication processor 221 transmits the SD response message to the acquisition terminal 3, the information amount of the contents-relevant information 10A included in the SD response message is greater than the upper limit value. In this case, in the distribution terminal 2 retaining the contents A, the control unit 210 detects that the own terminal is not capable of transmitting the SD response message including the contents-relevant information 10A, of which the information amount is greater than the upper limit value, as the transmission error. That is, the interrupt processing of the CPU 26 occurs (Step S205: Yes).

Therefore, in a case where the control unit 220 detects an error when the SD response message is transmitted, the distribution terminal 2 retaining the contents A performs the following processing.

First, in the distribution terminal 2 retaining the contents A, the first wireless communication processor 221 transmits the SD response message including the IP address of the own terminal to the acquisition terminal 3, without including the contents-relevant information 10A in the SD response message. Alternatively, the first wireless communication processor 221 transmits the second SD response message including the error occurrence flag and the IP address of the own terminal to the acquisition terminal 3, without including the contents-relevant information 10A in the SD response message (Step S209). The error occurrence flag included in the second SD response message (the SD response message of the second time) is information indicating the effect that an error occurs when the first SD response message (the SD response message of the first time) is transmitted. The SD response message including the error occurrence flag (the error notification) is received by the first wireless communication processor 321, and thus, the control unit 320 of the acquisition terminal 3 detects that an error occurs on the distribution terminal 2 side. In addition, the first wireless communication processor 321 of the acquisition terminal 3 receives the distribution terminal 2 retaining the SD response message transmitted from the contents A, and thus, discovers the distribution terminal 2 existing in the near field communication range (Step S206).

The contents-relevant information 10A is not included in the received SD response message, and thus, the first wireless communication processor 321 of the acquisition terminal 3 recognizes that the contents-relevant information 10A is capable of being acquired from the SD response message in the near field communication. Alternatively, the error occurrence flag is included in the received SD response message, and thus, the first wireless communication processor 321 of the acquisition terminal 3 recognizes that the contents-relevant information 10A is not capable of being acquired from the SD response message in the near field communication (Step S207: No). In this case, the second wireless communication processor 322 of the acquisition terminal 3 transmits the WiFi connection request to the distribution terminal 2 retaining the contents A by using the IP address included in the received SD response message, as the wireless communication connection request (Step S210).

In the distribution terminal 2 retaining the contents A, the second wireless communication processor 222 receives the WiFi connection request transmitted from the acquisition terminal 3 (Step S211). In this case, the second wireless communication processor 222 establishes the WiFi connection according to the WiFi connection request, as the wireless communication connection between the acquisition terminal 3 and the distribution terminal 2 retaining the contents A. In a case where the WiFi connection is performed between the acquisition terminal 3 and the distribution terminal 2 retaining the contents A, the second wireless communication processor 322 of the acquisition terminal 3 transmits the contents-relevant information request to the distribution terminal 2 retaining the contents A (Step S212).

In the distribution terminal 2 retaining the contents A, the second wireless communication processor 222 receives the contents-relevant information request transmitted from the acquisition terminal 3 (Step S213). In this case, the second wireless communication processor 222 transmits the contents-relevant information 10A according to the contents-relevant information request (Step S214). The second wireless communication processor 322 of the acquisition terminal 3 acquires the contents-relevant information 10A from the distribution terminal 2 retaining the contents A. The control unit 320 of the acquisition terminal 3 list-displays the icons of the contents A1 to A3, and the content names a1 to a3 on the display unit 32, as the acquired contents-relevant information 10A (Step S215).

After that, Steps S5, and S7 to S10 of FIG. 2 are performed. For example, in Step S5, the user selects the content name a1 of the contents A1. In Step S7, the second wireless communication processor 322 of the acquisition terminal 3 transmits the content transmission request for requesting the transmission of the contents A1 to the distribution terminal 2 retaining the contents A. In Step S8, the second wireless communication processor 222 of the distribution terminal 2 retaining the contents A transmits the contents A1 according to the content transmission request transmitted from the acquisition terminal 3. In Step S9, the second wireless communication processor 322 of the acquisition terminal 3 acquires the contents A1 from the distribution terminal 2 retaining the contents A1. The control unit 320 of the acquisition terminal 3 displays the acquired contents A1 on the display unit 32. Accordingly, the user of the acquisition terminal 3 is capable of browsing the contents A1.

As described above, in the distribution terminal 2 of the distribution system 1 of the second example, the first wireless communication processor 221 transmits the contents-relevant information 10A (the SD response message) according to the contents-relevant information request (the SD request message). At this time, the control unit 210 detects the occurrence of an error. In this case, the first wireless communication processor 221 transmits the error notification (the SD response message not including the contents-relevant information 10A) to the acquisition terminal 3. The second wireless communication processor 222 establishes the wireless communication connection (the WiFi connection) according to the wireless communication connection request (the WiFi connection request) transmitted from the acquisition terminal 3, when the acquisition terminal 3 receives the error notification (the SD response message not including the contents-relevant information 10A). Therefore, the second wireless communication processor 222 transmits the contents-relevant information 10A to the acquisition terminal 3 after the wireless communication connection (the WiFi connection) is established. Accordingly, in the distribution system 1 of the second example, even in a case where an error occurs when the SD response message including the contents-relevant information, of which the information amount is greater than the upper limit value, is transmitted, the distribution terminal 2 is capable of reliably distributing the contents-relevant information to the acquisition terminal 3.

In the first example and the second example, in a case where an error occurs on the distribution terminal 2 side when the distribution terminal 2 transmits the SD response message, the acquisition terminal 3 acquires the contents-relevant information by the WiFi connection between the distribution terminal 2 and the acquisition terminal 3. However, the embodiments are not limited thereto. For example, in a case where an error occurs when the SD response message is received, and thus, the contents-relevant information is not capable of being acquired from the SD response message, the acquisition terminal 3 may acquire the contents-relevant information by the WiFi connection between the distribution terminal 2 and the acquisition terminal 3. An example of this case will be described below as a third example. Furthermore, in the third example, the same reference numerals will be applied to the same constituents as those of the first example and the second example, and the repeated description of the constituents and the operations will be omitted.

### [c] Third Example

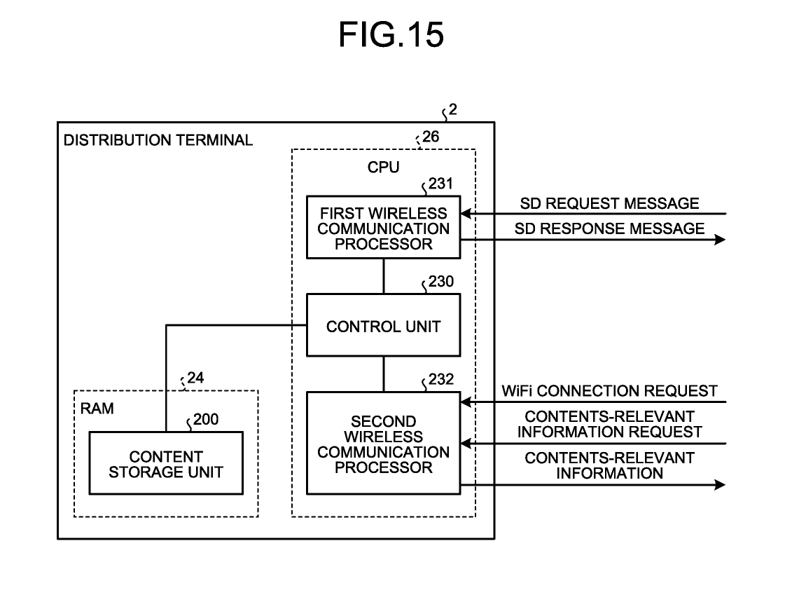

FIG. 15 is a block diagram illustrating an example of a functional configuration of the RAM 24 and the CPU 26 in the distribution terminal 2 of the distribution system 1 of the third example. The CPU 26 in the distribution terminal 2 is provided with a control unit 230, a first wireless communication processor 231, and a second wireless communication processor 232.

In a case where the own terminal exists in the near field communication range, the first wireless communication processor 231, for example, receives the SD request message transmitted from the acquisition terminal 3. When the SD request message is received, the first wireless communication processor 231 reads out the contents-relevant information from the content storage unit 200. The first wireless communication processor 231 transmits the SD response message including the contents-relevant information in the near field communication, as the contents-relevant information response.

On the other hand, there is a case where the first wireless communication processor 231 receives the SD request message transmitted again from the acquisition terminal 3. In this case, the first wireless communication processor 231 transmits the SD response message including the IP address of the own terminal to the acquisition terminal 3 according to the error occurrence flag included in the SD request message, without including the contents-relevant information in the SD response message.

Alternatively, the first wireless communication processor 231 transmits the SD response message including the error occurrence flag and the IP address of the own terminal to the acquisition terminal 3, without including the contents-relevant information 10A. The error occurrence flag included in the SD response message is information indicating the effect that an error occurs on the acquisition terminal 3 side.

In a case where the WiFi connection request transmitted from the acquisition terminal 3 is received, the second wireless communication processor 232 establishes the WiFi connection according to the WiFi connection request, as the wireless communication connection between the acquisition terminal 3 and the distribution terminal 2. In a case where the contents-relevant information request transmitted from the acquisition terminal 3 is received, the second wireless communication processor 232 transmits the contents-relevant information according to the contents-relevant information request.

The control unit 230 controls the entire CPU 26. In a case where the SD request message including the error occurrence flag (the error notification) is received by the first wireless communication processor 231, the control unit 230 detects that an error occurs on the acquisition terminal 3 side.

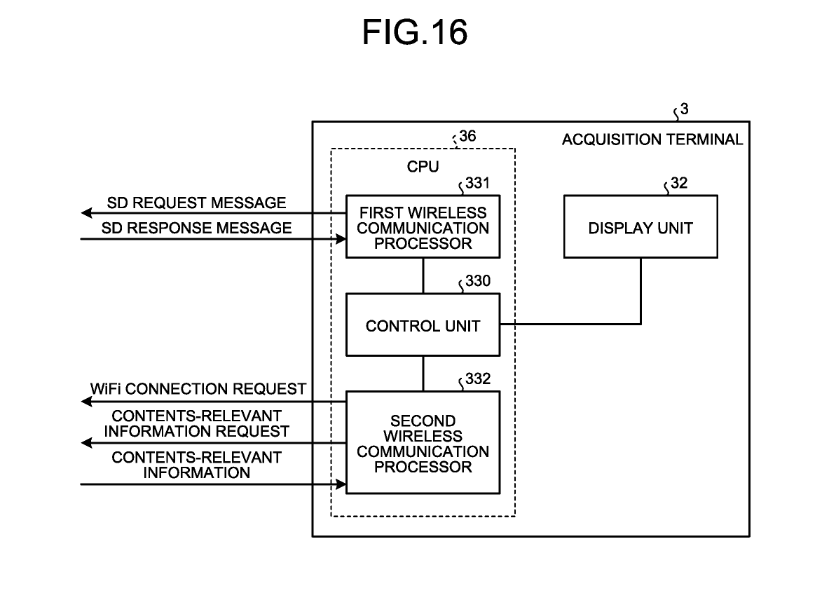

FIG. 16 is a block diagram illustrating an example of a functional configuration of the CPU 36 in the acquisition terminal 3 of the distribution system 1 of the third example. The CPU 36 in the acquisition terminal 3 is provided with a control unit 330, a first wireless communication processor 331, and a second wireless communication processor 332.

When the application is activated, or when the content-search instruction is performed on the application, the first wireless communication processor 331 transmits the SD request message in the near field communication, as the contents-relevant information request. The SD request message is transmitted from the acquisition terminal 3 by a broadcast. The first wireless communication processor 331 receives the SD response message transmitted from the distribution terminal 2, and thus, discovers the distribution terminal 2 existing in the near field communication range. When the SD response message is received, the first wireless communication processor 331 acquires the contents-relevant information included in the received SD response message.

On the other hand, in a case where an error is detected when the control unit 330 receives the SD response message, the first wireless communication processor 331 transmits the second SD request message including the error occurrence flag in the near field communication. The error occurrence flag included in the second SD request message (the SD request message of the second time) is information indicating the effect that an error occurs when the first SD response message (the SD request message of the first time) is received. The first wireless communication processor 331 receives the SD response message transmitted again from the distribution terminal 2. In a case where the contents-relevant information is not included in the received SD response message, the first wireless communication processor 331 recognizes that the contents-relevant information is not capable of being acquired from the SD response message in the near field communication. Alternatively, in a case where the error occurrence flag is included in the received SD response message, the first wireless communication processor 331 recognizes that the contents-relevant information is not capable of being acquired from the SD response message in the near field communication.

In a case where the first wireless communication processor 331 is not capable of acquiring the contents-relevant information from the second SD response message, the second wireless communication processor 332 transmits the WiFi connection request to the distribution terminal 2 by using the IP address included in the received SD response message, as the wireless communication connection request. In a case where the WiFi connection is performed between the acquisition terminal 3 and the distribution terminal 2, the second wireless communication processor 332 transmits the contents-relevant information request to the distribution terminal 2, and acquires contents-relevant information from the distribution terminal 2.

The control unit 330 controls the entire CPU 36. In a case where the own terminal is not capable of acquiring the contents-relevant information 10A from the SD response message received by the first wireless communication processor 331, the control unit 330 detects such a case as a reception error. In addition, the control unit 330 list-displays the acquired contents-relevant information on the display unit 32.

Here, when the first wireless communication processor 331 receives the SD response message, there is a case where the contents-relevant information is not capable of being acquired from the received SD response message. In this case, the control unit 330 detects that the contents-relevant information is not capable of being acquired from the received SD response message, as the reception error (for example, the occurrence of the exception, or the like).

In the third example, in the acquisition terminal 3, the first wireless communication processor 331 executes Steps S1 and S2 of FIG. 2, the second wireless communication processor 332 executes Steps S6, S7, and S10 of FIG. 2, and the control unit 330 executes Steps S4, S5, and S9 of FIG. 2. In each of the distribution terminals 2, the first wireless communication processor 231 executes Step S3 of FIG. 2, and the second wireless communication processor 232 executes Step S8 of FIG. 2.

Further, in the third example, as described below, even in a case where an error occurs when the acquisition terminal 3 receives the SD response message including the contents-relevant information from the distribution terminal 2, the distribution terminal 2 is capable of reliably distributing the contents-relevant information to the acquisition terminal 3.

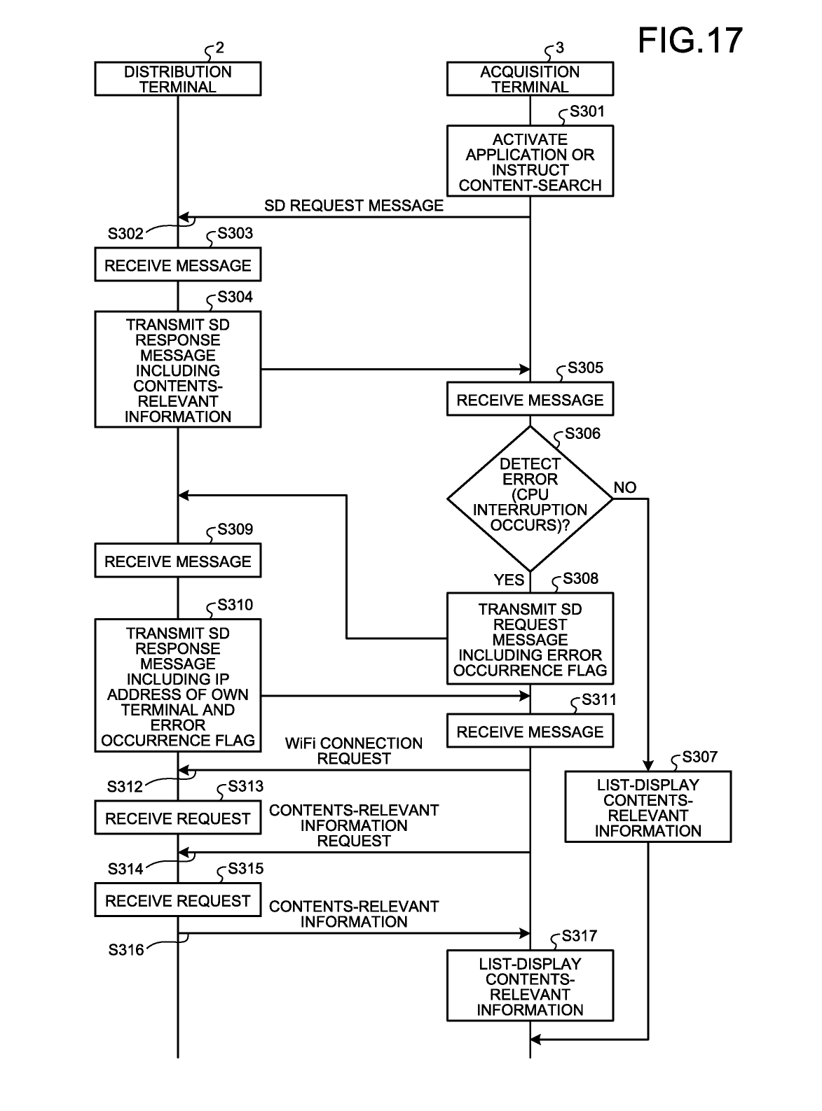

FIG. 17 is a sequence diagram illustrating an example of the operation of the distribution system 1 of the third example.

In the acquisition terminal 3, the application is activated according to the operation of the user. Alternatively, in the acquisition terminal 3, the content-search instruction is performed on the application according to the operation of the user (Step S301). At this time, the first wireless communication processor 331 of the acquisition terminal 3 transmits the SD request message in the near field communication, as the contents-relevant information request (Step S302). The SD request message is transmitted from the acquisition terminal 3 by a broadcast.

For example, the distribution terminal 2 retaining the contents A exists in the near field communication range. In this case, in the distribution terminal 2 retaining the contents A, the first wireless communication processor 231 receives the SD request message transmitted from the acquisition terminal 3 (Step S303). When the SD request message is received, the first wireless communication processor 231 reads out the contents-relevant information 10A from the content storage unit 200. The contents-relevant information 10A is information relevant to the contents A (the contents A1 to A3), and includes the icons of the contents A1 to A3, and the content names a1 to a3. The first wireless communication processor 231 transmits the SD response message including the contents-relevant information 10A in the near field communication, as the contents-relevant information response (Step S304).

For example, the first wireless communication processor 331 of the acquisition terminal 3 receives the SD response message transmitted from the distribution terminal 2 retaining the contents A, and thus, discovers the distribution terminal 2 existing in the near field communication range (Step S305).

Here, when the SD response message transmitted from the distribution terminal 2 retaining the contents A is received, the first wireless communication processor 331 of the acquisition terminal 3 acquires the contents-relevant information 10A included in the received SD response message. In this case, in the acquisition terminal 3, the contents-relevant information 10A can be acquired, and thus, the CPU 36 does not detect the reception error described below. That is, the interrupt processing of the CPU 36 does not occur (Step S306: No). The control unit 330 of the acquisition terminal 3 list-displays the icons of the contents A1 to A3, and the content names a1 to a3 on the display unit 32, as the acquired contents-relevant information 10A (Step S307).

On the other hand, when the SD response message transmitted from the distribution terminal 2 retaining the contents A is received, the first wireless communication processor 331 of the acquisition terminal 3 is not capable of acquiring the contents-relevant information 10A from the received SD response message. In this case, in the acquisition terminal 3, the control unit 330 detects that the own terminal is not capable of acquiring the contents-relevant information 10A from the received SD response message, as the reception error. That is, the interrupt processing of the CPU 36 occurs (Step S306: Yes).

Therefore, in a case where the control unit 330 detects an error when the SD response message is received, the acquisition terminal 3 performs the following processing.

First, the first wireless communication processor 331 of the acquisition terminal 3 transmits the second SD request message including the error occurrence flag in the near field communication (Step S308). The error occurrence flag included in the second SD request message (the SD request message of the second time) is information indicating the effect that an error occurs when the first SD response message (the SD response message of the first time) is received.

In the distribution terminal 2 retaining the contents A, the first wireless communication processor 231 receives the SD request message transmitted again from the acquisition terminal 3 (Step S309). The SD request message including the error occurrence flag (the error notification) is received by the first wireless communication processor 231, and thus, the control unit 230 detects that an error occurs on the acquisition terminal 3 side. In this case, the first wireless communication processor 231 transmits the SD response message including the IP address of the own terminal to the acquisition terminal 3 according to the error occurrence flag included in the SD request message, without including the contents-relevant information 10A. Alternatively, the first wireless communication processor 231 transmits the SD response message including the error occurrence flag and the IP address of the own terminal to the acquisition terminal 3, without including the contents-relevant information 10A (Step S310). The error occurrence flag included in the SD response message is information indicating the effect that an error occurs on the acquisition terminal 3 side. In this case, the error occurrence flag included in the SD response message may be identical to the error occurrence flag included in the second SD request message.

The first wireless communication processor 331 of the acquisition terminal 3 receives the SD response message transmitted again from the distribution terminal 2 retaining the contents A (Step S311). The contents-relevant information 10A is not included in the received SD response message, and thus, the first wireless communication processor 331 of the acquisition terminal 3 recognizes that the contents-relevant information 10A is not capable of being acquired from the SD response message in the near field communication. Alternatively, the error occurrence flag is included in the received SD response message, and thus, the first wireless communication processor 331 of the acquisition terminal 3 recognizes that the contents-relevant information 10A is not capable of being acquired from the SD response message in the near field communication. In this case, the second wireless communication processor 332 of the acquisition terminal 3 transmits the WiFi connection request to the distribution terminal 2 retaining the contents A by using the IP address included in the received SD response message, as the wireless communication connection request (Step S312).

In the distribution terminal 2 retaining the contents A, the second wireless communication processor 232 receives the WiFi connection request transmitted from the acquisition terminal 3 (Step S313). In this case, the second wireless communication processor 232 establishes the WiFi connection according to the WiFi connection request, as the wireless communication connection between the acquisition terminal 3 and the distribution terminal 2 retaining the contents A. In a case where the WiFi connection is performed between the acquisition terminal 3 and the distribution terminal 2 retaining the contents A, the second wireless communication processor 332 of the acquisition terminal 3 transmits the contents-relevant information request to the distribution terminal 2 retaining the contents A (Step S314).

In the distribution terminal 2 retaining the contents A, the second wireless communication processor 232 receives the contents-relevant information request transmitted from the acquisition terminal 3 (Step S315). In this case, the second wireless communication processor 232 transmits contents-relevant information 10A according to the contents-relevant information request (Step S316). The second wireless communication processor 332 of the acquisition terminal 3 acquires the contents-relevant information 10A from the distribution terminal 2 retaining the contents A. The control unit 330 of the acquisition terminal 3 list-displays the icons of the contents A1 to A3, and the content names a1 to a3 on the display unit 32, as the acquired contents-relevant information 10A (Step S317).

After that, Steps S5, and S7 to S10 of FIG. 2 are performed. For example, in Step S5, the user selects the content name a1 of the contents A1. In Step S7, the second wireless communication processor 332 of the acquisition terminal 3 transmits the content transmission request for requesting the transmission of the contents A1 to the distribution terminal 2 retaining the contents A. In Step S8, the second wireless communication processor 232 of the distribution terminal 2 retaining the contents A transmits the contents A1 according to the content transmission request transmitted from the acquisition terminal 3. In Step S9, the second wireless communication processor 332 of the acquisition terminal 3 acquires the contents A1 from the distribution terminal 2 retaining the contents A1. The control unit 330 of the acquisition terminal 3 displays the acquired contents A1 on the display unit 32. Accordingly, the user of the acquisition terminal 3 is capable of browsing the contents A1.

As described above, in the distribution terminal 2 of the distribution system 1 of the third example, the first wireless communication processor 231 transmits the contents-relevant information 10A (the SD response message) according to the contents-relevant information request (the SD request message). At this time, the control unit 210 detects the occurrence of an error by the error notification from the acquisition terminal 3 (by receiving again the SD request message). In this case, the first wireless communication processor 231 transmits an error response (the SD response message not including the contents-relevant information 10A) with respect to the error notification (the re-reception of the SD request message) to the acquisition terminal 3. The second wireless communication processor 232 establishes the wireless communication connection (the WiFi connection) according to the wireless communication connection request (the WiFi connection request) transmitted from the acquisition terminal 3 when the acquisition terminal 3 receives the error response (the SD response message not including the contents-relevant information 10A). The second wireless communication processor 232 transmits the contents-relevant information 10A to the acquisition terminal 3 after the wireless communication connection (the WiFi connection) is established. Accordingly, in the distribution system 1 of the third example, even in a case where an error occurs when the acquisition terminal 3 receives the SD response message including the contents-relevant information from the distribution terminal 2, the distribution terminal 2 is capable of reliably distributing the contents-relevant information to the acquisition terminal 3.

In the distribution terminal 2 of the first example and the second example, in a case where the information amount of the contents-relevant information is greater than the upper limit value when the SD response message is transmitted, an error occurs. In the acquisition terminal 3 of the third example, an error occurs when the SD response message is received. Here, for example, the upper limit value of the transmittable information amount may be stored in advance in the storage unit of the distribution terminal 2, and the distribution terminal 2 may transmit the SD response message on the basis of a comparison result between the information amount of the contents-relevant information and the upper limit value stored in the storage unit, such that an error does not occur. An example of this case will be described below as a fourth example. Furthermore, in the fourth example, the same reference numerals will be applied to the same constituents as those of the first example to the third example, and the repeated description of the constituents and the operations will be omitted.

### [d] Fourth Example

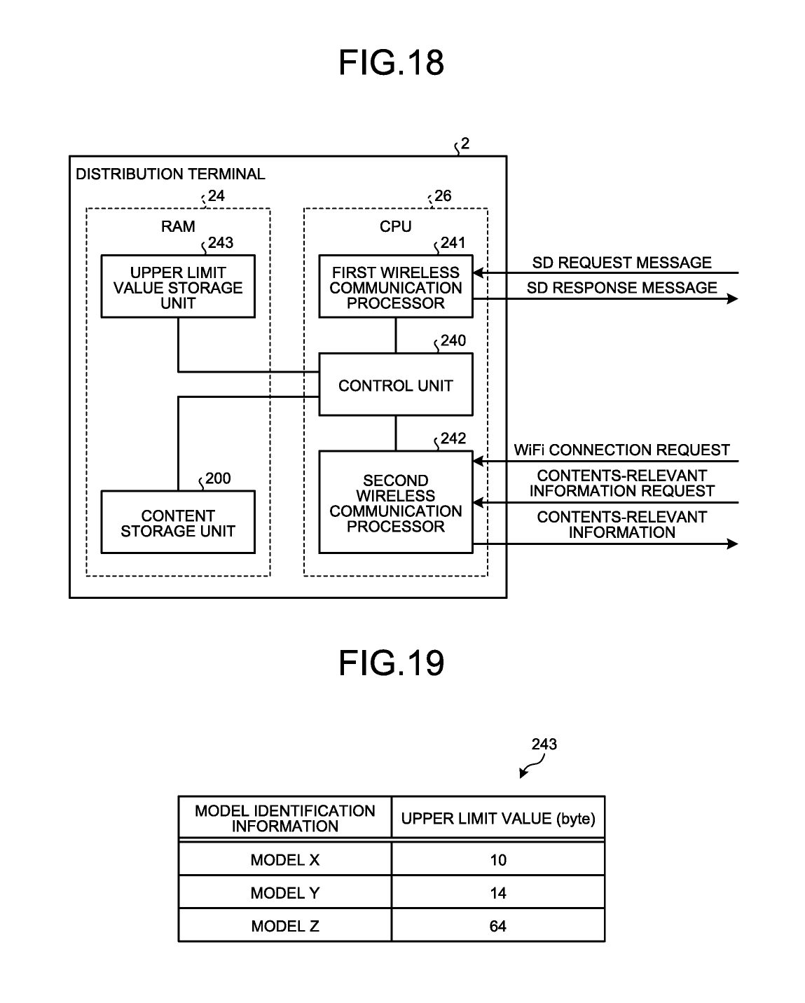

FIG. 18 is a block diagram illustrating an example of a functional configuration of the RAM 24 and the CPU 26 in the distribution terminal 2 of the distribution system 1 of the fourth example. As illustrated in FIG. 18, the RAM 24 in the distribution terminal 2 is further provided with an upper limit value storage unit 243.

FIG. 19 is a diagram illustrating an example of the upper limit value storage unit 243 in the distribution terminal 2. The upper limit value storage unit 243 stores model identification information, and an upper limit value of the transmittable information amount. For example, the upper limit value storage unit 243 stores the model identification information of “model X”, and the upper limit value of “10 (byte)” in association with each other. In addition, the upper limit value storage unit 243 stores the model identification information of “model Y”, and the upper limit value of “14 (byte)” in association with each other. In addition, the upper limit value storage unit 243 stores the model identification information of “model Z”, and the upper limit value of “64 (byte)” in association with each other.

For example, in a case where the distribution terminal 2 is the distribution terminal 2 retaining the contents A, the model identification information of the distribution terminal 2 is “model Z”. For example, in a case where the distribution terminal 2 is the distribution terminal 2 retaining the contents B, the model identification information of the distribution terminal 2 is “model Y”. For example, in a case where the distribution terminal 2 is the distribution terminal 2 retaining the contents C, the model identification information of the distribution terminal 2 is “model X”.

As illustrated in FIG. 18, the CPU 26 in the distribution terminal 2 is provided with a control unit 240, a first wireless communication processor 241, and a second wireless communication processor 242.

The first wireless communication processor 241 acquires the upper limit value associated with the model identification information of the own terminal from the upper limit value storage unit 243 at the time of being activated.

In a case where the own terminal exists in the near field communication range, the first wireless communication processor 241, for example, receives the SD request message transmitted from the acquisition terminal 3. When the SD request message is received, the first wireless communication processor 241 reads out the contents-relevant information from the content storage unit 200. Next, the first wireless communication processor 241 calculates the information amount of the contents-relevant information, and determines whether or not the information amount of the contents-relevant information is greater than the upper limit value.

Here, in a case where the information amount of the contents-relevant information is not greater than the upper limit value, the first wireless communication processor 241 includes the contents-relevant information in the SD response message, and transmits the SD response message to the acquisition terminal 3, as the contents-relevant information response. In a case where the information amount of the contents-relevant information is greater than the upper limit value, the first wireless communication processor 241 includes the IP address of the own terminal, without including the contents-relevant information 10A in the SD response message, and transmits the SD response message to the acquisition terminal 3, as the contents-relevant information response.

In a case where the WiFi connection request transmitted from the acquisition terminal 3 is received, the second wireless communication processor 242 establishes the WiFi connection according to the WiFi connection request, as the wireless communication connection between the acquisition terminal 3 and the distribution terminal 2. In a case where the contents-relevant information request transmitted from the acquisition terminal 3 is received, the second wireless communication processor 242 transmits the contents-relevant information according to the contents-relevant information request.

The control unit 240 controls the entire CPU 26. In a case where the information amount of the contents-relevant information is greater than the upper limit value, the control unit 240 detects that an error occurs when the SD response message is transmitted from the own terminal.

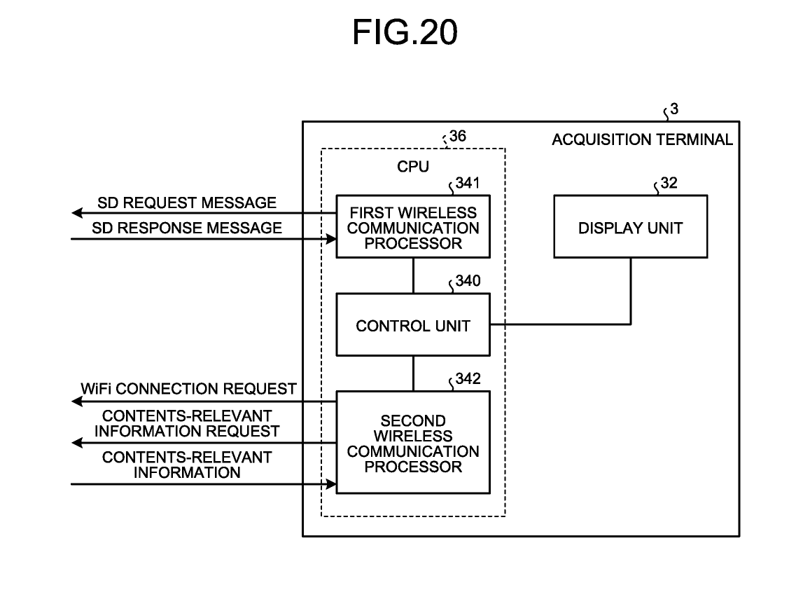

FIG. 20 is a block diagram illustrating an example of a functional configuration of the CPU 36 in the acquisition terminal 3 of the distribution system 1 of the fourth example. The CPU 36 in the acquisition terminal 3 is provided with a control unit 340, a first wireless communication processor 341, and a second wireless communication processor 342.

When the application is activated, or when the content-search instruction is performed on the application, the first wireless communication processor 341 transmits the SD request message in the near field communication, as the contents-relevant information request. The SD request message is transmitted from the acquisition terminal 3 by a broadcast. The first wireless communication processor 341 receives the SD response message transmitted from the distribution terminal 2, and thus, discovers the distribution terminal 2 existing in the near field communication range. When the SD response message is received, the first wireless communication processor 341 acquires the contents-relevant information included in the received SD response message.

On the other hand, in a case where the contents-relevant information is not included in the received SD response message, the first wireless communication processor 341 recognizes that the contents-relevant information is not capable of being acquired from the SD response message in the near field communication.

In a case where the first wireless communication processor 341 is not capable of acquiring the contents-relevant information from the SD response message, the second wireless communication processor 342 transmits the WiFi connection request to the distribution terminal 2 by using the IP address included in the received SD response message, as the wireless communication connection request. In a case where the WiFi connection is performed between the acquisition terminal 3 and the distribution terminal 2, the second wireless communication processor 342 transmits the contents-relevant information request to the distribution terminal 2, and acquires the contents-relevant information from the distribution terminal 2.

The control unit 340 controls the entire CPU 36. The control unit 340 list-displays the acquired contents-relevant information on the display unit 32.

In the fourth example, in the acquisition terminal 3, the first wireless communication processor 341 executes Steps S1 and S2 of FIG. 2, the second wireless communication processor 342 executes Steps S6, S7, and S10 of FIG. 2, and the control unit 340 executes Steps S4, S5, and S9 of FIG. 2. In each of the distribution terminals 2, the first wireless communication processor 241 executes Step S3 of FIG. 2, and the second wireless communication processor 242 executes Step S8 of FIG. 2.

Further, in the fourth example, as described below, even in a case where the information amount of the contents-relevant information is greater than a setting value set in the distribution terminal 2 (the upper limit value), the distribution terminal 2 is capable of reliably distributing the contents-relevant information to the acquisition terminal 3.

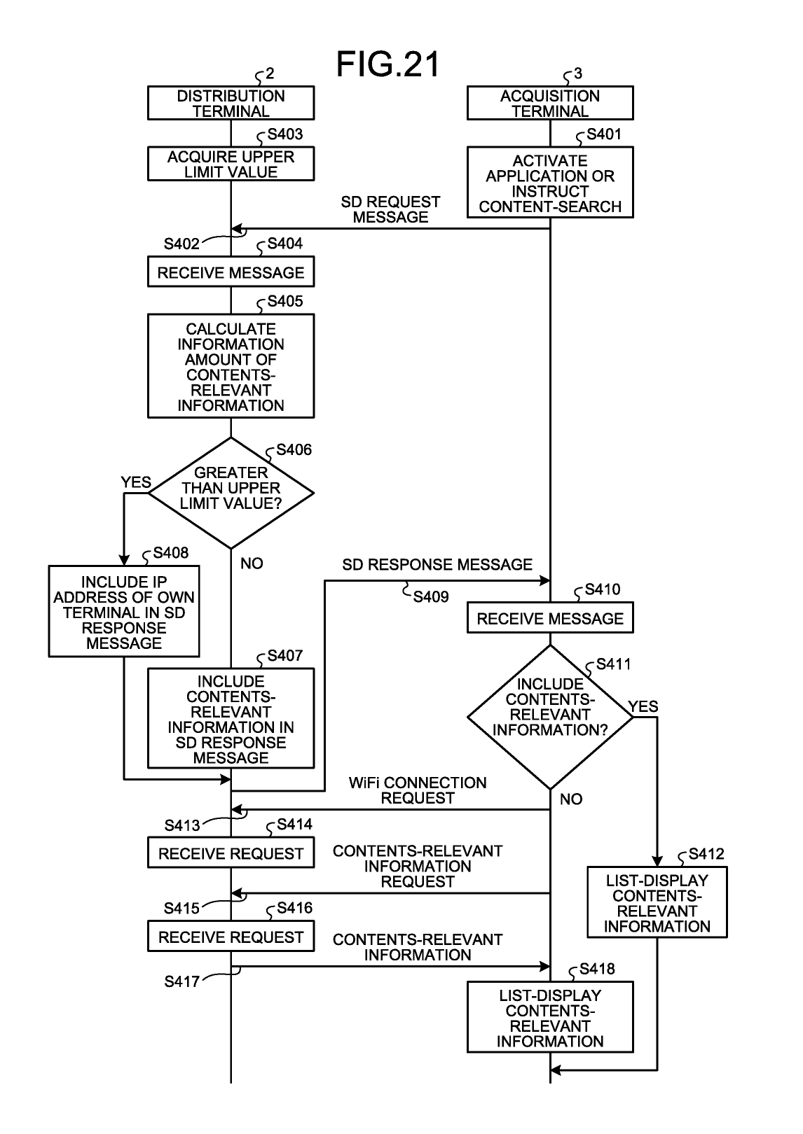

FIG. 21 is a sequence diagram illustrating an example of the operation of the distribution system 1 of the fourth example.

In the acquisition terminal 3, the application is activated according to the operation of the user. Alternatively, in the acquisition terminal 3, the content-search instruction is performed on the application according to the operation of the user (Step S401). At this time, the first wireless communication processor 341 of the acquisition terminal 3 transmits the SD request message in the near field communication, as the contents-relevant information request (Step S402). The SD request message is transmitted from the acquisition terminal 3 by a broadcast.

In addition, the first wireless communication processor 241 of the distribution terminal 2 acquires the upper limit value associated with the model identification information of the own terminal from the upper limit value storage unit 243 at the time of being activated (Step S403). For example, in a case where the distribution terminal 2 is the distribution terminal 2 retaining the contents A, the first wireless communication processor 241 of the distribution terminal 2 retaining the contents A acquires the upper limit value of “64 (byte)” associated with the model identification information of “model Z” of the own terminal from the upper limit value storage unit 243.

For example, the distribution terminal 2 retaining the contents A exists in the near field communication range. In this case, in the distribution terminal 2 retaining the contents A, the first wireless communication processor 241 receives the SD request message transmitted from the acquisition terminal 3 (Step S404). When the SD request message is received, the first wireless communication processor 241 reads out the contents-relevant information 10A from the content storage unit 200. The contents-relevant information 10A is information relevant to the contents A (the contents A1 to A3), and includes the icons of the contents A1 to A3, and the content names a1 to a3. Next, the first wireless communication processor 241 calculates the information amount of the contents-relevant information 10A (Step S405). Next, the first wireless communication processor 241 determines whether or not the information amount of the contents-relevant information 10A is greater than the upper limit value of “64 (byte)” (Step S406).

Here, the information amount of the contents-relevant information 10A is not greater than the upper limit value of “64 (byte)” (Step S406: No). In this case, in the distribution terminal 2 retaining the contents A, the control unit 240 does not detect the occurrence of an error. The first wireless communication processor 241 includes the contents-relevant information 10A in the SD response message (Step S407). Next, the first wireless communication processor 241 transmits the SD response message including the contents-relevant information 10A to the acquisition terminal 3, as the contents-relevant information response (Step S409).

On the other hand, the information amount of the contents-relevant information 10A is greater than the upper limit value of “64 (byte)” (Step S406: Yes). In this case, in the distribution terminal 2 retaining the contents A, the control unit 240 detects that an error occurs when the SD response message is transmitted from the own terminal. Therefore, the first wireless communication processor 241 includes the IP address of the own terminal, without including the contents-relevant information 10A in the SD response message (Step S408). Next, the first wireless communication processor 241 transmits the SD response message including the IP address of the own terminal to the acquisition terminal 3, as the contents-relevant information response (Step S409).

The first wireless communication processor 341 of the acquisition terminal 3 receives the SD response message transmitted from the distribution terminal 2 retaining the contents A, and thus, discovers the distribution terminal 2 existing in the near field communication range (Step S410).

Here, the contents-relevant information 10A is included in the SD response message received by the acquisition terminal 3 (Step S411: Yes). In this case, the first wireless communication processor 341 of the acquisition terminal 3 is capable of acquiring the contents-relevant information 10A. The control unit 340 of the acquisition terminal 3 list-displays the icons of the contents A1 to A3, and the content names a1 to a3 on the display unit 32, as the acquired contents-relevant information 10A (Step S412).

On the other hand, the contents-relevant information 10A is not included in the SD response message received by the acquisition terminal 3 (Step S411: No). In this case, the first wireless communication processor 341 of the acquisition terminal 3 recognizes that the contents-relevant information 10A is not capable of being acquired from the SD response message in the near field communication. In this case, the second wireless communication processor 342 of the acquisition terminal 3 transmits the WiFi connection request to the distribution terminal 2 retaining the contents A by using the IP address included in the received SD response message, as the wireless communication connection request (Step S413).

In the distribution terminal 2 retaining the contents A, the second wireless communication processor 242 receives the WiFi connection request transmitted from the acquisition terminal 3 (Step S414). In this case, the second wireless communication processor 242 establishes the WiFi connection according to the WiFi connection request, as the wireless communication connection between the acquisition terminal 3 and the distribution terminal 2 retaining the contents A. In a case where the WiFi connection is performed between the acquisition terminal 3 and the distribution terminal 2 retaining the contents A, the second wireless communication processor 342 of the acquisition terminal 3 transmits the contents-relevant information request to the distribution terminal 2 retaining the contents A (Step S415).

In the distribution terminal 2 retaining the contents A, the second wireless communication processor 242 receives the contents-relevant information request transmitted from the acquisition terminal 3 (Step S416). In this case, the second wireless communication processor 242 transmits the contents-relevant information 10A according to the contents-relevant information request (Step S417). The second wireless communication processor 342 of the acquisition terminal 3 acquires the contents-relevant information 10A from the distribution terminal 2 retaining the contents A. The control unit 340 of the acquisition terminal 3 list-displays the icons of the contents A1 to A3, and the content names a1 to a3 on the display unit 32, as the acquired contents-relevant information 10A (Step S418).

After that, Steps S5, and S7 to S10 of FIG. 2 are performed. For example, in Step S5, the user selects the content name a1 of the contents A1. In Step S7, the second wireless communication processor 342 of the acquisition terminal 3 transmits the content transmission request for requesting the transmission of the contents A1 to the distribution terminal 2 retaining the contents A. In Step S8, the second wireless communication processor 242 of the distribution terminal 2 retaining the contents A transmits the contents A1 according to the content transmission request transmitted from the acquisition terminal 3. In Step S9, the second wireless communication processor 342 of the acquisition terminal 3 acquires the contents A1 from the distribution terminal 2 retaining the contents A1. The control unit 340 of the acquisition terminal 3 displays the acquired contents A1 on the display unit 32. Accordingly, the user of the acquisition terminal 3 is capable of browsing the contents A1.

As described above, in the distribution terminal 2 of the distribution system 1 of the fourth example, the control unit 230 detects the occurrence of an error in a case where the information amount of the contents-relevant information 10A is greater than the upper limit value of the transmittable information amount. Here, the control unit 230 does not detect the occurrence of an error. In this case, the first wireless communication processor 241 transmits the contents-relevant information 10A (the SD response message) to the acquisition terminal 3 according to the contents-relevant information request (the SD request message) transmitted from the acquisition terminal 3 before the wireless communication connection (the WiFi connection) is established. On the other hand, in a case where the control unit 230 detects the occurrence of an error, the second wireless communication processor 242 transmits the contents-relevant information 10A to the acquisition terminal 3 after the wireless communication connection (the WiFi connection) is established.

Accordingly, in the distribution system 1 of the fourth example, even in a case where the information amount of the contents-relevant information is greater than the setting value set in the distribution terminal 2 (the upper limit value), the distribution terminal 2 is capable of reliably distributing the contents-relevant information to the acquisition terminal 3.

### OTHER EXAMPLES

Each constituent of each unit illustrated in the first example to the fourth example may be physically configured different from the drawings. That is, a specific aspect of distribution and integration of each of the units is not limited to that illustrated, and all or a part thereof may be configured by being functionally or physically distributed or integrated in arbitrary unit, according to various loads, usage conditions, or the like.

Further, all or any part of various processings performed in each of the devices may be executed on a central processing unit (CPU) (or a micro computer such as a micro processing unit (MPU) or a micro controller unit (MCU)). In addition, all or any part of various processings may be executed on a program, which is analyzed and executed by the CPU (or the micro computer such as the MPU or the MCU), or on hardware of wired logic.

An area storing various information items, for example, may be configured of a read only memory (ROM) or a random access memory (RAM) such as synchronous dynamic random access memory (SDRAM), magnetoresistive random access memory (MRAM), and non volatile random access memory (NVRAM).

In one aspect, it is possible to reliably distribute contents-relevant information from a distribution terminal to an acquisition terminal.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A distribution terminal comprising:
a memory; and
a processor coupled to the memory, wherein the processor executes a process comprising:
first transmitting contents-relevant information relevant to contents to an acquisition terminal before wireless communication connection is established, according to a contents-relevant information request which is transmitted from the acquisition terminal;
detecting whether or not an error occurs when the contents-relevant information is transmitted; and
second transmitting the contents-relevant information to the acquisition terminal after the wireless communication connection is established, in a case in which an occurrence of the error is detected.

2. The distribution terminal according to claim 1,
wherein the second transmitting includes
transmitting a wireless communication connection request establishing the wireless communication connection to the acquisition terminal, in a case in which the occurrence of an error is detected at the detecting, and
transmitting the contents-relevant information to the acquisition terminal after the wireless communication connection is established.

3. The distribution terminal according to claim 1,
wherein the process further comprises transmitting an error notification to the acquisition terminal, in a case in which the occurrence of an error is detected at the detecting, and
the second transmitting includes
establishing the wireless communication connection, according to a wireless communication connection request which is transmitted from the acquisition terminal that receives the error notification, and
transmitting the contents-relevant information to the acquisition terminal after the wireless communication connection is established.

4. The distribution terminal according to claim 1,
wherein the process further comprises transmitting an error response with respect to an error notification to the acquisition terminal in a case where the occurrence of an error is detected based on the error notification from the acquisition terminal at the detecting, and
the second transmitting includes
establishing the wireless communication connection, according to a wireless communication connection request which is transmitted from the acquisition terminal that receives the error response, and
transmitting the contents-relevant information to the acquisition terminal after the wireless communication connection is established.

5. The distribution terminal according to claim 1,
wherein the detecting includes detecting the occurrence of an error in a case in which an information amount of the contents-relevant information is greater than an upper limit value,
the first transmitting includes transmitting the contents-relevant information to the acquisition terminal before the wireless communication connection is established, according to the contents-relevant information request which is transmitted from the acquisition terminal, in a case in which the occurrence of an error is not detected at the detecting, and
the second transmitting includes transmitting the contents-relevant information to the acquisition terminal after the wireless communication connection is established, in a case in which the occurrence of an error is detected at the detecting.

6. An acquisition terminal comprising:
a memory; and
a processor coupled to the memory, wherein the processor executes a process comprising:
transmitting a contents-relevant information request to a distribution terminal before wireless communication connection is established; and
acquiring contents-relevant information after the wireless communication connection is established, in a case in which the contents-relevant information relevant to contents is not acquired from the distribution terminal, when the contents-relevant information request is transmitted.

7. A distribution system, comprising:
an acquisition terminal; and
a distribution terminal that retains contents,
wherein the distribution terminal comprises:
a memory; and
a processor coupled to the memory, wherein the processor executes a process comprising:
transmitting contents-relevant information relevant to the contents to the acquisition terminal before wireless communication connection is established, according to a contents-relevant information request which is transmitted from the acquisition terminal;
detecting whether or not an error occurs when the contents-relevant information is transmitted; and
transmitting the contents-relevant information to the acquisition terminal after the wireless communication connection is established, in a case in which an occurrence of the error is detected.

8. A distribution method implemented by a distribution terminal, the distribution method comprising:
transmitting contents-relevant information relevant to contents to an acquisition terminal before wireless communication connection is established, according to a contents-relevant information request which is transmitted from the acquisition terminal, using a processor of the distribution terminal;
detecting whether or not an error occurs when the contents-relevant information is transmitted, using the processor; and
transmitting the contents-relevant information to the acquisition terminal after the wireless communication connection is established, in a case in which the occurrence of the error is detected, using the processor.
